(19) United States
(12) Patent Application Publication
(10) Pub. No.: US 2006/0111342 A1
(43) Pub. Date: May 25, 2006

(54) Insecticidal tricyclic derivatives

(76) Inventors: Joseph A. Argentine, Tabernacle, NJ (US); Franz A. Schuler, Basel (CH); John A. Dixson, Newton, PA (US); Scott D. Crawford, Jackson, NJ (US); Daniel H. Cohen, Princeton, NJ (US); Elizabeth G. Rowley, Kendall Park, NJ (US); Saroj Sehgel, Princeton Junction, NJ (US)

Correspondence Address: John M Sheehan;FMC Corporation, Patent Administrator, 1735 Market Street, Philadelphia, PA, 19103, US

(21) Appl. No.: 10/528,740

(22) PCT Filed: Sep. 12, 2003
(86) PCT No.: PCT/US03/28791

§ 371 Date: Aug. 9, 2005

Related U.S. Application Data
(60) Provisional application No. 60/411,926, filed on Sep. 18, 2002.

(51) Int. Cl. A01N 43/62; A01N 43/42; A01N 43/00; A01N 43/46; A01N 43/58; A01N 43/60

(52) U.S. Cl. 514/217; 514/218; 514/253.03; 514/297; 514/250

(57) ABSTRACT

It has now been found that certain tricyclic derivatives have provided unexpected insecticidal activity. These compounds are represented by formula I: wherein R¹ through R⁸, inclusively, and X and Y are fully described. Compositions comprising an insecticidally effective amount of at least one compound of formula I, and optionally, an effective amount of at least one of a second compound, with at least one insecticidally compatible carrier are also disclosed; along with methods of controlling insects comprising applying said compositions to the locus where insects are present or are expected to be present.

### FIELD OF THE INVENTION

The present invention generally relates to insecticidal compounds and their use in controlling insects. In particular, it pertains to insecticidal tricyclic derivatives and agriculturally acceptable salts thereof, compositions of these insecticides, and methods for their use in controlling insects.

### BACKGROUND OF THE INVENTION

It is well known that insects can cause significant damage to crops grown in agriculture, resulting in loss of millions of dollars of value associated with a given crop. Although there are many orders of insects that can cause significant crop damage, insects of the suborder “Homoptera” are of major importance. The suborder Homoptera includes, for example, aphids, leafhoppers, cicadas, whiteflies, and mealybugs, to name a few. Homopterans have piercing/sucking mouthparts, enabling them to feed by withdrawing sap from vascular plants. Insect damage from homopterans is manifested in several different ways, other than damage caused by direct feeding. For example, many species excrete honeydew, a sticky waste product that adheres to plants upon which the insect feeds and lives. Honeydew alone causes cosmetic injury to crop plants. Sooty molds will often grow on honeydew, making food products or ornamental plants look unappealing, thereby reducing their cosmetic and economic value. Some homopterans have toxic saliva that is injected into plants while they are feeding. The saliva can cause plant damage through disfigurement and in some instances plant death. Homopterans can also vector disease-causing pathogens. Unlike direct damage, it does not take a large number of disease-vectoring insects to cause considerable damage to crop plants.

Accordingly, there is a continuing demand for new-insecticides for control of, for example, Homoptera and other orders of insects; as well as new acaricides, that are safer, more effective, and less costly for use on crops such as wheat, corn, soybeans, potatoes, and cotton to name a few. For crop protection, insecticides and acaricides are desired which can control the insects and acarids without damaging the crops, and have no deleterious effects to mammals and other living organisms.

Its equivalent WO93/00811 and U.S. Pat. No. 5,366,975 disclose a method of controlling an invertebrate pest, comprising contacting the pest with a pest-controlling amount of an agent having substantial inhibitory activity toward a phenylethanolamine reuptake transporter as determined by a radioactive octopamine reuptake inhibition assay. Compounds in compositions capable of inhibiting the octopamine transporter set forth in WO93/00811 and U.S. Pat. No. 5,366,975 include tricyclic antidepressants, wherein the tricyclic antidepressants exemplified are desipramine, amitriptyline, imipramine, amoxapine, nortriptyline, protriptyline, maprotiline, and doxepin, and pharmaceutically acceptable salts thereof. Desipramine and amitriptyline are specifically shown to have anti-feeding activity against tobacco hornworm. The tricyclic antipruritic cyproheptadine is also disclosed as having anti-feeding activity against tobacco hornworm.

The disclosure of invertebrate pesticidal activity of certain tricyclic antidepressants and antipruritics in WO93/00811 and U.S. Pat. No. 5,366,975, based on the limited data presented therein, does not suggest insecticidal activity, or the degree of that insecticidal activity, of other tricyclic derivatives whose antidepressant or antipruritic activity is unknown.

U.S. Pat. No. 3,436,397 claims a class of dibenzocyclohepten-5-ylidene thiazolidinones of the formula: 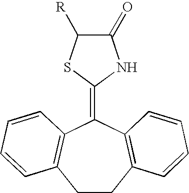
wherein R is selected from the group which consists of hydrogen and C₁-C₄ alkyl. The dibenzocyclohepten-5-ylidene thiazolidinones are reported to have larvicidal activity against horse strongyles, anthelminthic activity against Syphacia obvelata and are useful for the treatment of pinworm infestations in mammals, and also possess antibacterial activity against certain gram-positive and gram-negative organisms.

There is no disclosure or suggestion in U.S. Pat. No. 3,436,397 that any of the compounds disclosed therein have insecticidal activity.

### SUMMARY OF THE INVENTION

In accordance with the present invention, it has now been found that certain tricyclic derivatives (hereinafter termed “compounds of formula I”) and agriculturally acceptable salts thereof are surprisingly active when used in the insecticidal compositions and methods of this invention. The compounds of formula I are represented by the following general formula I: 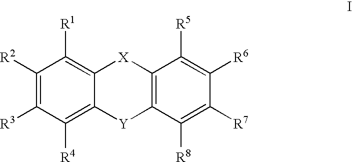
wherein
R¹ through R⁸, inclusively, are independently selected from hydrogen, halogen, alkyl, cycloalkyl, alkenyl, alkynyl, trialkylsilylalkynyl, alkoxy, haloalkyl, haloalkoxy, alkylthio, alkylsulfinyl, alkylsulfonyl, haloalkylthio, haloalkylsulfinyl, haloalkylsulfonyl, dialkylaminosulfonyl, nitro, cyano, amino, formyl, or alkylcarbonyl;
X is selected from —CR⁹R¹⁰—, —CR¹¹R¹²CR¹³R¹⁴—, —CR¹⁵═CR¹⁶—, NR¹⁷—, —CR¹⁸R¹⁹NR²⁰—, or —CR²¹═N—;
   and
Y is selected from —CR²²R²³, —CR²⁴R—CR²⁶R²⁷—, CR²═CR²⁹—, —NR³⁰—, —CR³¹R³²NR³³—, —O—, —S—, —S(O)—, —S(O)₂—, —CR³⁴R³⁵O—, —CR³⁶R³⁷S—, or —CR³⁸═N—;
   where
R⁹ and R¹⁰ are independently selected from hydrogen, alkyl, or (piperidin-4-yl)alkyl;
   or
R⁹ and R¹⁰ may be taken together with 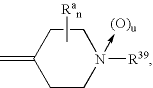
   or with ═CHC₂H₄NR⁴⁰R⁴¹,
   where
R³⁹, R⁴⁰ and R⁴¹ are independently selected from hydrogen; alkyl; hydroxylalkyl; alkoxyalkyl; alkylthioalkyl; alkoxycarbonylalkyl; haloalkoxycarbonyl; arylalkyl; aryloxyalkyl; arylcarbonylalkyl; arylcarbonyloxyalkyl, wherein aryl is optionally substituted with one or more halogen, alkoxy, haloalkyl, or aryl;
   or
R⁴⁰ and R⁴¹ may be taken together with —C₂H₄N(CH₃)C₂H₄— to form a piperazine ring;
u is 0 or 1,
and when u is 1, an N-oxide is formed;
n is 0, and R^{a} is hydrogen;
   or
n is 1 to 8, and R^{a} is selected from one or more of alkyl, alkoxyalkyl, alkoxycarbonyl, and aryl, wherein aryl is optionally substituted with one or more halogen, alkoxy, haloalkyl, or aryl;
R¹¹ is selected from hydrogen, alkyl, alkylaminoalkoxy, dialkylaminoalkoxy, N(alkyl)(alkylaminoalkyl), N(alkyl)(dialkylaminoalkyl), alkylaminoalkylalkynyl, dialkylaminoalkylalkynyl, morpholinyl, imidazolinyl, alkylpyrrolidinyloxy, 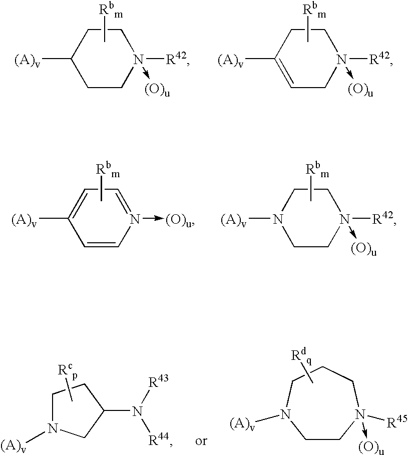
   where
   v is 0 or 1,
   and when v is 1, A is a bridging group selected from —O—, —S—, —NH—, and —CH₂—;
   u is as described above;
R⁴² through R⁴⁵, inclusively, are independently selected from hydrogen; alkyl; alkenyl; alkynyl; hydroxylalkyl; alkoxyalkyl; alkylthioalkyl; alkylcarbonyl; alkoxycarbonylalkyl; haloalkoxycarbonyl; arylalkyl; aryloxyalkyl; arylcarbonylalkyl; arylcarbonyloxyalkyl; heteroaryl; heteroarylalkyl; heteroarylalkylamino; wherein aryl and heteroaryl are optionally substituted with one or more halogen, alkoxy, haloalkyl, or aryl;
   or
R⁴³ and R⁴⁴ may be taken together with —C₅H₁₀— to form a piperidine ring; m, p, and q are 0, and R^{b}, R^{c} and R^{d} are hydrogen;
   or
m is 1 to 8, p is 1 to 7, and q is 1 to 10, and R^{b}, R^{c}, and R^{d}, respectively, are independently selected from one or more of alkyl, alkoxyalkyl, alkylamino, dialkylamino, alkoxycarbonyl, or aryl, wherein aryl is optionally substituted with one or more halogen, alkoxy, haloalkyl, or aryl;
   or
R¹¹ and R¹² may be taken together with 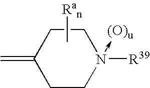
   where R^{a}, n, u, and R³⁹ are as described above;
R¹², when not taken together with R¹¹, and R¹³, R¹⁴, and R¹⁶, are independently selected from hydrogen, hydroxy, halogen, alkyl, alkoxy, alkylcarbonyl, alkylcarbonyloxy, alkoxycarbonyl, alkoxycarbonyloxy, alkylaminocarbonyl, dialkylaminocarbonyl, alkylaminocarbonyloxy, dialkylaminocarbonyloxy, alkylaminosulfonyl, or dialkylaminosulfonyl;
R¹⁵ is selected from 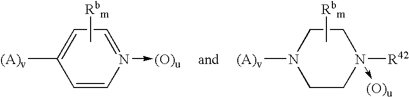
   where m, u, v, A, R^{b} and R⁴² are as described above;
R¹⁷ is hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl; 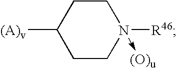
   or —C₃H₆NR⁴⁷R⁴⁸
   where
A, v, and u are as described above;
R⁴⁶ is selected from selected from hydrogen; alkyl; alkenyl; alkynyl; hydroxylalkyl; alkoxyalkyl; alkylthioalkyl; alkylcarbonyl; alkoxycarbonylalkyl; haloalkoxycarbonyl; arylalkyl; aryloxyalkyl; arylcarbonylalkyl; arylcarbonyloxyalkyl; heteroaryl; heteroarylalkyl; heteroarylalkylamino; wherein aryl and heteroaryl are optionally substituted with one or more halogen, alkoxy, haloalkyl, or aryl;
R⁴⁷ and R⁴⁸ are independently selected from hydrogen and alkyl;
   or
R⁴⁷ and R⁴⁸ may be taken together with —C₅H₁₀— to form a piperidine ring, or with —C₂H₄N(CH₃)C₂H₄—, or —C₂H₄N(C₂H₄₀H)C₂H₄— to form a piperazine ring;
R¹⁸ and R¹⁹ are independently selected from hydrogen, alkyl, amino, alkylaminoalkyl, and dialkylaminoalkyl;
R²⁰ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R²¹ is selected from hydrogen, alkyl, 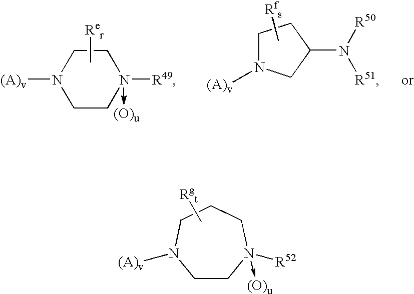
   where
A, v, and u are as described above;
R⁴⁹ through R⁵², inclusively, are independently selected from hydrogen; alkyl; alkenyl, alkynyl, hydroxylalkyl; alkoxyalkyl; alkylthioalkyl; alkylcarbonyl, alkoxycarbonylalkyl; haloalkoxycarbonyl; arylalkyl; aryloxyalkyl; arylcarbonylalkyl; arylcarbonyloxyalkyl, heteroaryl, heteroarylalkyl, heteroarylalkylamino, wherein aryl and heteroaryl are optionally substituted with one or more halogen, alkoxy, haloalkyl, or aryl;
   or
R⁵⁰ and R⁵¹ may be taken together with —C₅H₁₀— to form a piperidine ring;
r, s, and t are 0, and R^{e}, R^{f}, and R^{g} are hydrogen,
   or
r is 1 to 8, s is 1 to 7, t is 1 to 10, and R^{e}, R^{f}, and R^{g}, respectively, are independently selected from one or more of alkyl, alkoxyalkyl, alkylamino, dialkylamino, alkoxycarbonyl, or aryl, wherein aryl is optionally substituted with one or more halogen, alkoxy, haloalkyl, or aryl;
R²² through R²⁹, inclusively, are independently selected from hydrogen, and alkyl;
R³⁰ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R³¹ and R³² are independently selected from hydrogen, and alkyl,
R³³ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R³⁴ through R³⁸, inclusively, are independently selected from hydrogen, and alkyl;
   and,
   agriculturally acceptable salts thereof.

The present invention is also directed to compositions containing an insecticidally effective amount of at least one of a compound of formula I, and optionally, an effective amount of at least one of a second compound, with at least one insecticidally compatible carrier.

The present invention is also directed to methods of controlling insects, where control is desired, which comprise applying an insecticidally effective amount of the above composition to the locus of crops, or other areas where insects are present or are expected to be present.

### DETAILED DESCRIPTION OF THE INVENTION

One aspect of the present invention is insecticidal compositions comprising at least one of an insecticidally effective amount of a compound of formula I and at least one insecticidally compatible carrier therefor, wherein the compound of formula I is: 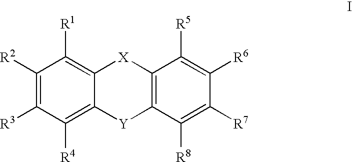
wherein
R¹ through R⁸, inclusively, are independently selected from hydrogen, halogen, alkyl, cycloalkyl, alkenyl, alkynyl, trialkylsilylalkynyl, alkoxy, haloalkyl, haloalkoxy, alkylthio, alkylsulfinyl, alkylsulfonyl, haloalkylthio, haloalkylsulfinyl, haloalkylsulfonyl, dialkylaminosulfonyl, nitro, cyano, amino, formyl, or alkylcarbonyl;
X is selected from —CR⁹R¹⁰—, —CR¹¹R¹²CR¹³R¹⁴—, —CR¹⁵═CR¹⁶—, —NR¹⁷—, —CR¹⁸R¹⁹NR²⁰—, or —CR²¹═N—;
   and
Y is selected from —CR²²R²³—, —CR²⁴R²⁵CR²⁶R²⁷—, —CR²⁸═CR²⁹, —N³⁰, —CR³¹R³²NR²²—, —O—, —S—, —S(O)—, —S(O)₂—, —CR³⁴R³⁵O—, —CR³⁶R³⁷S—, or —CR³⁸═N—;
   where
R⁹ and R¹⁰ are independently selected from hydrogen, alkyl, or (piperidin-4-yl)alkyl;
   or
R⁹ and R¹⁰ may be taken together with 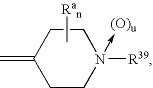
   or with ═CHC₂H₄NR⁴⁰R⁴¹,
   where
R³⁹, R⁴⁰ and R⁴¹ are independently selected from hydrogen; alkyl; hydroxylalkyl; alkoxyalkyl; alkylthioalkyl; alkoxycarbonylalkyl; haloalkoxycarbonyl; arylalkyl; aryloxyalkyl; arylcarbonylalkyl; arylcarbonyloxyalkyl, wherein aryl is optionally substituted with one or more halogen, alkoxy, haloalkyl, or aryl;
   or
R⁴⁰ and R⁴¹ may be taken together with —C₂H₄N(CH₃)C₂H₄— to form a piperazine ring;
u is 0 or 1,
and when u is 1, an N-oxide is formed;
n is 0, and R^{a} is hydrogen;
   or
n is 1 to 8, and R^{a} is selected from one or more of alkyl, alkoxyalkyl, alkoxycarbonyl, and aryl, wherein aryl is optionally substituted with one or more halogen, alkoxy, haloalkyl, or aryl;
R¹¹ is selected from hydrogen, alkyl, alkylaminoalkoxy, dialkylaminoalkoxy, N(alkyl)(alkylaminoalkyl), N(alkyl)(dialkylaminoalkyl), alkylaminoalkylalkynyl, dialkylaminoalkylalkynyl, morpholinyl, imidazolinyl, alkylpyrrolidinyloxy, 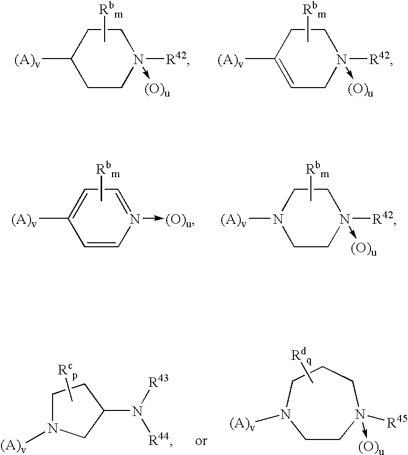
   where
v is 0 or 1,
   and when v is 1, A is abridging group selected from —O—, —S—, —NH—, and —CH₂—;
u is as described above;
R⁴² through R⁴⁵, inclusively, are independently selected from hydrogen; alkyl; alkenyl; alkynyl; hydroxylalkyl; alkoxyalkyl; alkylthioalkyl; alkylcarbonyl; alkoxycarbonylalkyl; haloalkoxycarbonyl; arylalkyl; aryloxyalkyl; arylcarbonylalkyl; arylcarbonyloxyalkyl; heteroaryl; heteroarylalkyl; heteroarylalkylamino; wherein aryl and heteroaryl are optionally substituted with one or more halogen, alkoxy, haloalkyl, or aryl;
   or
R⁴³ and R⁴⁴ may be taken together with —C₅H₁₀— to form a piperidine ring;
m, p, and q are 0, and R^{b}, R^{c} and R^{d} are hydrogen;
   or
m is 1 to 8, p is 1 to 7, and q is 1 to 10, and R^{b}, R^{c}, and R^{d}, respectively, are independently selected from one or more of alkyl, alkoxyalkyl, alkylamino, dialkylamino, alkoxycarbonyl, or aryl, wherein aryl is optionally substituted with one or more halogen, alkoxy, haloalkyl, or aryl;
   or
R¹¹ and R¹² may be taken together with 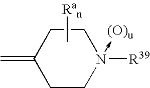
   where R^{a}, n, u, and R³⁹ are as described above;
R¹², when not taken together with R¹¹, and R¹³, R¹⁴, and R¹⁶, are independently selected from hydrogen, hydroxy, halogen, alkyl, alkoxy, alkylcarbonyl, alkylcarbonyloxy, alkoxycarbonyl, alkoxycarbonyloxy, alkylaminocarbonyl, dialkylaminocarbonyl, alkylaminocarbonyloxy, dialkylaminocarbonyloxy, alkylaminosulfonyl, or dialkylaminosulfonyl;
R¹⁵ is selected from 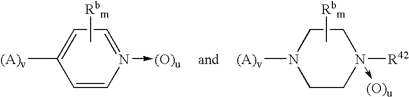
   where m, u, v, A, R^{b} and R⁴² are as described above;
R¹⁷ is hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl; 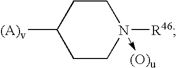
   or —C₃H₆N⁴⁷R^{48 where}
A, v, and u are as described above;
R⁴⁶ is selected from selected from hydrogen; alkyl; alkenyl; alkynyl; hydroxylalkyl; alkoxyalkyl; alkylthioalkyl; alkylcarbonyl; alkoxycarbonylalkyl; haloalkoxycarbonyl; arylalkyl; aryloxyalkyl; arylcarbonylalkyl; arylcarbonyloxyalkyl; heteroaryl; heteroarylalkyl; heteroarylalkylamino; wherein aryl and heteroaryl are optionally substituted with one or more halogen, alkoxy, haloalkyl, or aryl;
R⁴⁷ and R⁴⁸ are independently selected from hydrogen and alkyl;
   or
R⁴⁷ and R⁴⁸ may be taken together with —C₅H₁₀— to form a piperidine ring, or with —C₂H₄N(CH₃)C₂H₄—, or —C₂H₄N(C₂H₄OH)C₂H₄— to form a piperazine ring;
R¹⁸ and R¹⁹ are independently selected from hydrogen, alkyl, amino, alkylaminoalkyl, and dialkylaminoalkyl;
R²⁰ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R²¹ is selected from hydrogen, alkyl, 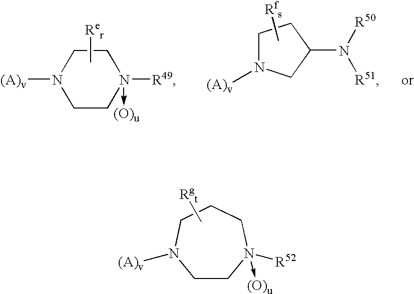
   where
A, v, and u are as described above;
R⁴⁹ through R⁵², inclusively, are independently selected from hydrogen; alkyl; alkenyl, alkynyl, hydroxylalkyl; alkoxyalkyl; alkylthioalkyl; alkylcarbonyl, alkoxycarbonylalkyl; haloalkoxycarbonyl; arylalkyl; aryloxyalkyl; arylcarbonylalkyl; arylcarbonyloxyalkyl, heteroaryl, heteroarylalkyl, heteroarylalkylamino, wherein aryl and heteroaryl are optionally substituted with one or more halogen, alkoxy, haloalkyl, or aryl;
   or
R⁵⁰ and R⁵¹ may be taken together with —C₅H₁₀— to form a piperidine ring;
r, s, and t are 0, and R^{e}, R^{f}, and R^{g} are hydrogen,
   or
r is 1 to 8, s is 1 to 7, t is 1 to 10, and R^{e}, R^{f}, and R^{g}, respectively, are independently selected from one or more of alkyl, alkoxyalkyl, alkylamino, dialkylamino, alkoxycarbonyl, or aryl, wherein aryl is optionally substituted with one or more halogen, alkoxy, haloalkyl, or aryl;
R²² through R²⁹, inclusively, are independently selected from hydrogen, and alkyl;
R³⁰ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R³¹ and R³² are independently selected from hydrogen, and alkyl,
R³³ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R³⁴ through R³⁸, inclusively, are independently selected from hydrogen, and alkyl;
   and,
   agriculturally acceptable salts thereof.

Preferred insecticidal compositions of the present invention are comprised of compounds of formula I, wherein X is —CR⁹R¹⁰— and Y is selected from —O—, —S—, —CR²²R²³—, and CR³⁴R³⁵O—;

where

R⁹ and R¹⁰ are taken together with 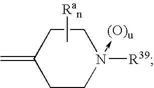
   where
R³⁹ is selected from hydrogen; alkyl; hydroxylalkyl; alkoxyalkyl; alkylthioalkyl; alkoxycarbonylalkyl; haloalkoxycarbonyl; arylalkyl; aryloxyalkyl; arylcarbonylalkyl; arylcarbonyloxyalkyl, wherein aryl is optionally substituted with one or more halogen, alkoxy, haloalkyl, or aryl;
   and,
R²², R², R³⁴ and R³⁵ are independently selected from hydrogen and alkyl.

Other preferred insecticidal compositions of the present invention are comprised of compounds of formula I, wherein X is —CR¹¹R¹²CR¹³R¹⁴— and Y is selected from —O—, —S— and —CR²²R²³;

where

R¹¹ is selected from 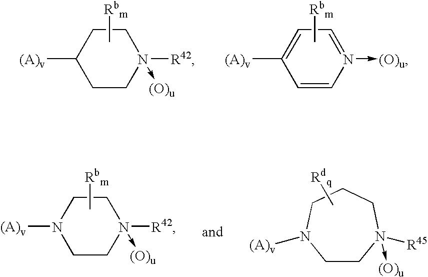
   where
R⁴² and R⁴⁵ are independently selected from hydrogen; alkyl; alkenyl; alkynyl; hydroxylalkyl; alkoxyalkyl; alkylthioalkyl; alkylcarbonyl; alkoxycarbonylalkyl; haloalkoxycarbonyl; arylalkyl; aryloxyalkyl; arylcarbonylalkyl; arylcarbonyloxyalkyl; heteroaryl; heteroarylalkyl; heteroarylalkylamino; wherein aryl and heteroaryl are optionally substituted with one or more halogen, alkoxy, haloalkyl, or aryl;
R¹² is selected from selected from hydrogen, hydroxy, halogen, alkyl, alkoxy, alkylcarbonyl, alkylcarbonyloxy, alkoxycarbonyl, alkoxycarbonyloxy, alkylaminocarbonyl, dialkylaminocarbonyl, alkylaminocarbonyloxy, dialkylaminocarbonyloxy, alkylaminosulfonyl, and dialkylaminosulfonyl;
R¹³ and R¹⁴ are hydrogen; and,
R²² and R²³ are independently selected from hydrogen and alkyl.

Yet other preferred insecticidal compositions of the present invention are comprised of compounds of formula I, wherein X is —CR¹⁸R¹⁹NR²⁰— and Y is selected from —O—, —S— and —CR²²R²³;

where

R²⁰ is selected from hydrogen, alkyl, alkoxyalkyl, alkoxycarbonyl, dialkylaminoalkyl, alkylaminocarbonyl, and dialkylaminocarbonyl;
   and,
R²² and R²³ are independently selected from hydrogen and alkyl.

Yet still other preferred insecticidal compositions of the present invention are comprised of compounds of formula I, wherein X is —R²¹═N— and Y is selected from —S— and —CR²²R²³—;
where R²¹ is 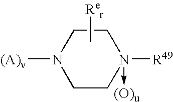
where
R⁴⁹ is selected from hydrogen; alkyl; alkenyl, alkynyl, hydroxylalkyl; alkoxyalkyl; alkylthioalkyl; alkylcarbonyl, alkoxycarbonylalkyl; haloalkoxycarbonyl; arylalkyl; aryloxyalkyl; arylcarbonylalkyl; arylcarbonyloxyalkyl, heteroaryl, heteroarylalkyl, heteroarylalkylamino, wherein aryl and heteroaryl are optionally substituted with one or more halogen, alkoxy, haloalkyl, or aryl;
   and,
R²² and R²³ are independently selected from hydrogen and alkyl.

One skilled in the art will, of course, recognize that certain combinations of X and Y as set forth above, for example, when X is —CR⁹R¹⁰— and Y is —NR³⁰—, or when X is —NR¹⁷— and Y is —CR²²R²³—, may lead to duplicity of compounds of formula I. Such duplicity of compounds is outside the scope of the present invention.

Certain compounds within the scope of formula I, which find utility in the novel insecticidal compositions of the present invention, may be new and novel compositions of matter. In addition, in certain cases the compounds within the scope of formula I may possess asymmetric centers, which can give rise to optical enantiomorphs and diastereomers. Compounds within the scope of formula I may exist in two or more forms, i.e., polymorphs, which are significantly different in physical and chemical properties. Compounds within the scope of formula I may also exist as tautomers, which are in equilibrium. Compounds within the scope of formula I may also possess acidic or basic moieties, which may allow for the formation of agriculturally acceptable salts or agriculturally acceptable metal complexes.

This invention includes the use of such enantiomorphs, polymorphs, tautomers, salts and metal complexes. Agriculturally acceptable salts and metal complexes include, without limitation, for example, ammonium salts, the salts of organic and inorganic acids, such as hydrochloric acid, sulfonic acid, ethanesulfonic acid, trifluoroacetic acid, methylbenzenesulfonic acid, phosphoric acid, gluconic acid, pamoic acid, and other acid salts, and the alkali metal and alkaline earth metal complexes with, for example, sodium, potassium, lithium, magnesium, calcium, and other metals.

The methods of the present invention are predicated on causing an insecticidally effective amount of a compound of formula I to be present within insects in order to kill or control the insects. Preferred insecticidally effective amounts are those that are sufficient to kill the insect. It is within the scope of the present invention to cause a compound of formula I to be present within insects by contacting the insects with a derivative of that compound, which derivative is converted within the insect to a compound of formula I. This invention includes the use of such compounds, which can be referred to as pro-insecticides.

Another aspect of the present invention relates to compositions containing an insecticidally effective amount of at least one compound of formula I, and, optionally, an effective amount of at least one second compound, with at least one insecticidally compatible carrier therefor.

Another aspect of the present invention relates to methods of controlling insects by applying an insecticidally effective amount of a composition set forth above to a locus of crops such as, without limitation, cereals, cotton, vegetables, and fruits, or other areas where insects are present or are expected to be present.

The present invention also includes the use of the compounds and compositions set forth herein for control of non-agricultural insect species, for example, dry wood termites and subterranean termites; as well as for use as pharmaceutical agents and compositions thereof.

As used in this specification and unless otherwise indicated the substituent terms “alkyl”, “alkenyl”, “alkynyl”, “alkoxy”, “alkenyl”, and “alkynyl” used alone or as part of a larger moiety, includes straight or branched chains of at least one or two carbon atoms, as appropriate to the substituent, and preferably up to 12 carbon atoms, more preferably up to ten carbon atoms, most preferably up to seven carbon atoms, wherein “alkenyl” has at least one carbon to carbon double bond, and “alkynyl” has at least one carbon to carbon triple bond. The term “aryl” refers to an aromatic ring structure, including fused rings, having four to ten carbon atoms, for example, phenyl and naphthyl. The term “heteroaryl” refers to an aromatic ring structure, including fused rings, having four to ten carbon atoms, and in which one or more of the atoms in the ring is other than carbon, for example, sulfur, oxygen, or nitrogen. The term “THF” refers to tetrahydrofuran. The term “DMF” refers to N,N-dimethylformamide. The term “halogen” or “halo” refers to fluorine, bromine, iodine, or chlorine. The term “ambient temperature” or “room temperature” often abbreviated as “RT”, for example, in reference to a chemical reaction mixture temperature, refers to a temperature in the range of 20° C. to 30° C. The term “insecticidal composition” refers to a composition containing an insecticide capable of killing an insect pest. The term “insecticidally effective amount” refers a composition containing an insecticide that is applied at a rate of application of insecticide sufficient to kill an insect pest.

The tricyclic derivatives of formula I can be synthesized by methods that are individually known to one skilled in the art from intermediate compounds readily available in commerce. Scheme 1 below illustrates a general procedure for synthesizing tricyclic derivatives of formula I, where, for example, X is —CR⁹R¹⁰—, and Y is —O— or —S—, where R⁹ and R¹⁰ are taken together with

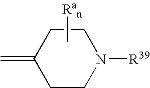

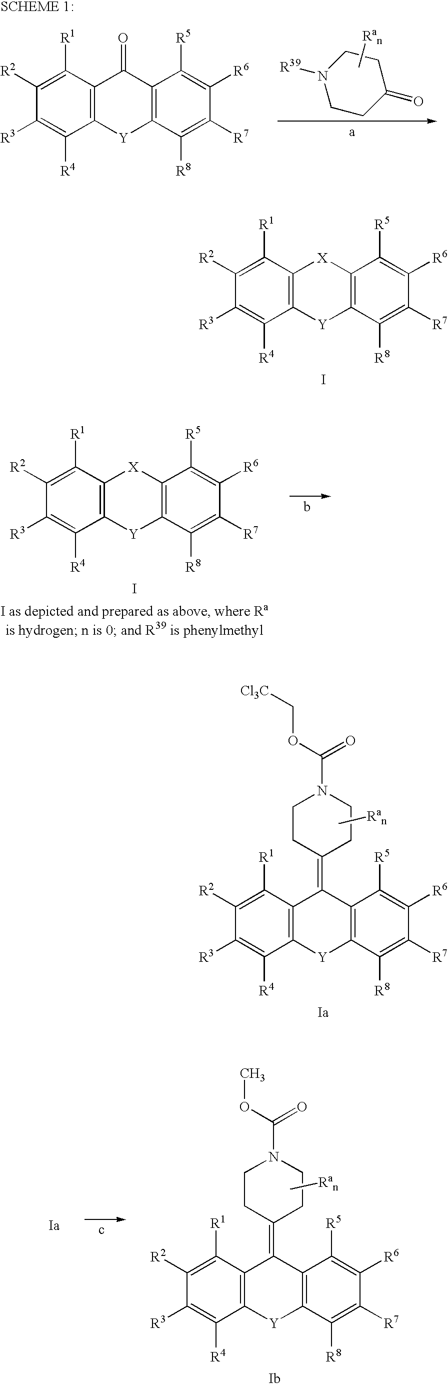

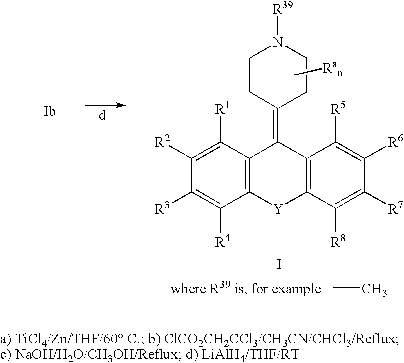

As depicted in Scheme 1, compounds of formula I, for example, where X is —CR⁹R¹⁰—, and Y is —O— or —S—, and where R⁹ and R¹⁰ are taken together with 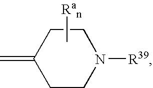
were prepared in one-step syntheses by reacting, for example, thioxanthen-9-one (Y is —S—), 1-methyl-4-piperidone, titanium(IV) chloride, and zinc in an appropriate solvent, affording the corresponding 10-(1-methyl-4-piperidylidene)benzo[b,e]thiane, a compound of formula I.

Other compounds of formula I were prepared in multi-step syntheses, for example, xanthone (Y is —O—), was reacted with 1-phenylmethyl-4-piperidone, zinc, and titanium(IV) chloride in an appropriate solvent, as set forth above, yielding the corresponding 9-(1-phenylmethyl-4-piperidylidene)xanthene. The xanthene intermediate was, in turn, reacted with 2,2,2-trichloroethyl chloroformate in an appropriate solvent, affording the corresponding 9-[1-(2,2,2-trichloroethoxycarbonyl)-4-piperidylidene]xanthene (Ia). Intermediate (Ia) was then treated with a strong base for example, sodium hydroxide, and an appropriate alcohol, such as methanol, yielding the corresponding 9-(1-methoxycarbonyl-4-piperidylidene)xanthene (Ib), which was, in turn, reduced with, for example, lithium aluminum hydride in an appropriate solvent, affording 9-(1-methyl-4-piperidylidene)xanthene, a compound of formula I.

Scheme 2 below illustrates a general procedure for synthesizing tricyclic derivatives of formula I, where, for example, X is —CR²¹═N— and and Y is —O— or —S—, where R²¹ is

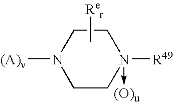

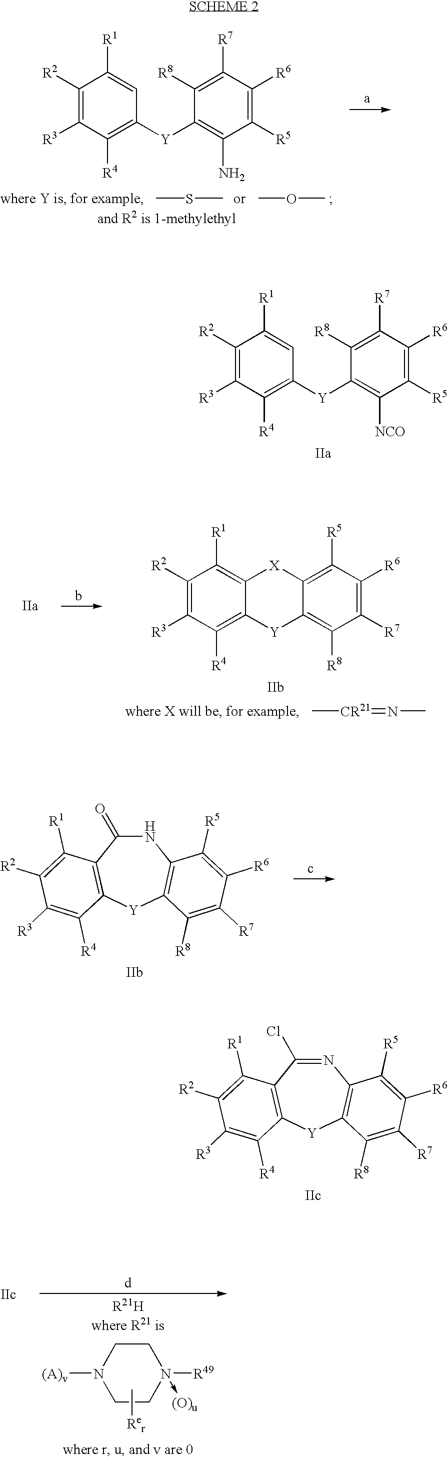

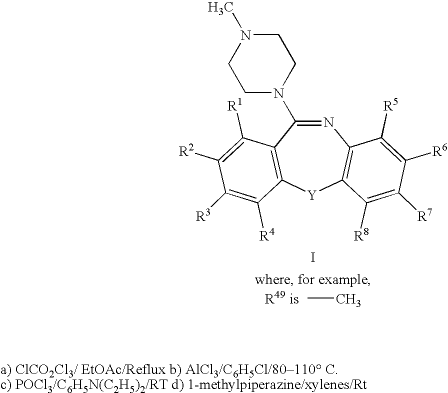

As depicted in Scheme 2, those compounds of formula I, for example, where X is —CR²¹═N— and Y is —O— or —S—, were also prepared in multi-step syntheses. For example, the known amine, 2-[4-(methylethyl)phenylthio]phenylamine (Y is S), was reacted with trichloromethyl chloroformate in an appropriate solvent, affording the corresponding isocyanate IIa. Intermediate IIa was in turn cyclized with aluminum chloride in an appropriate high-boiling solvent such as chlorobenzene, yielding the corresponding cyclized ketone derivative IIb, for example 2-(methylethyl)-10-dibenzo[b,f]-1,4-thiazaperhydroepin-11-one. Intermediate IIb was then chlorinated with, for example, phosphorous oxychloride in the presence of a base catalyst, providing the corresponding chloride derivative IIc. The so-prepared chloride derivative IIc, for example, 11-chloro-2-(methylethyl)dibenzo[b,f]1,4-thiazepine, was then converted to compounds of formula I by reacting it with an appropriate amine, for example 1-methylpiperazine, providing the compound 2-(methylethyl)-11-(4-methylpiperazinyl)dibenzo[b,f]1,4-thiazepine I.

Scheme 3 below illustrates a general procedure for synthesizing tricyclic derivatives of formula I, where, for example, X is CR¹¹R¹²CR¹³R¹⁴ and Y is —O— or —S—, and R¹¹ and R¹² represent a number of moieties. 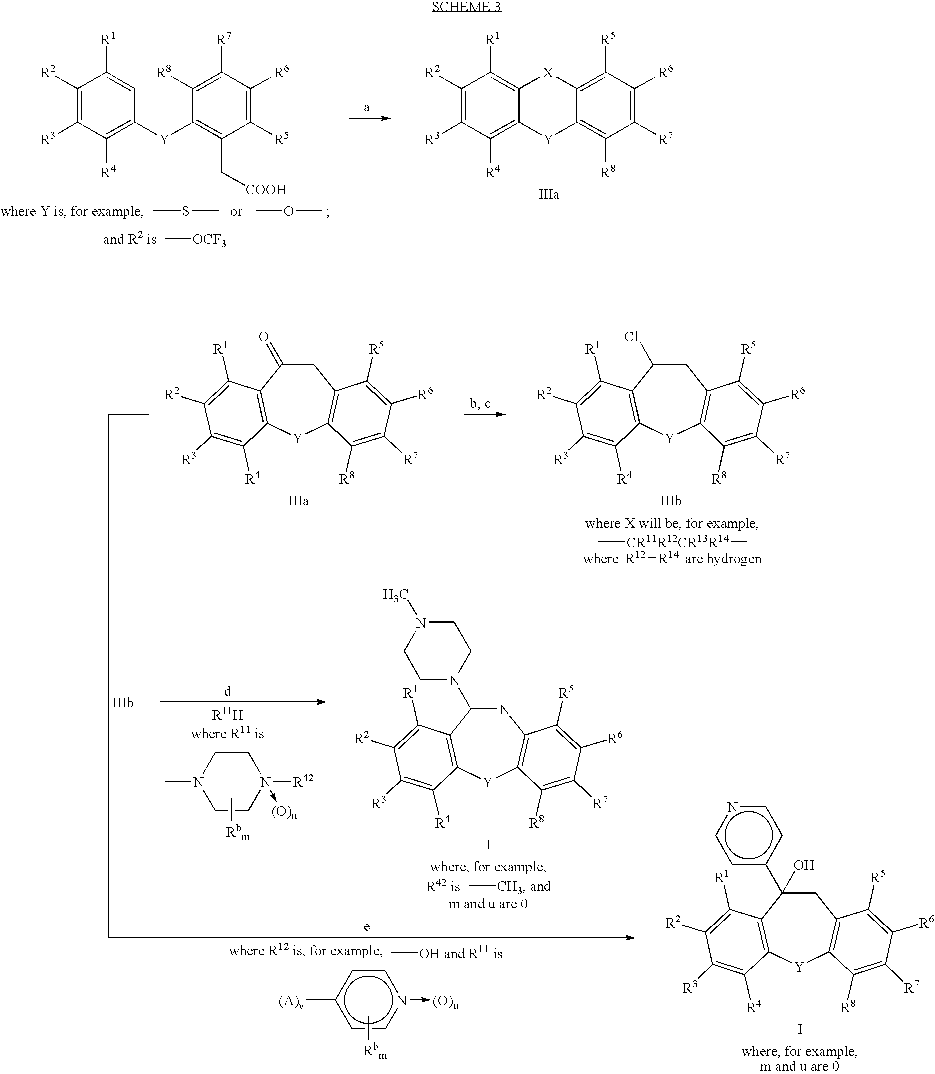 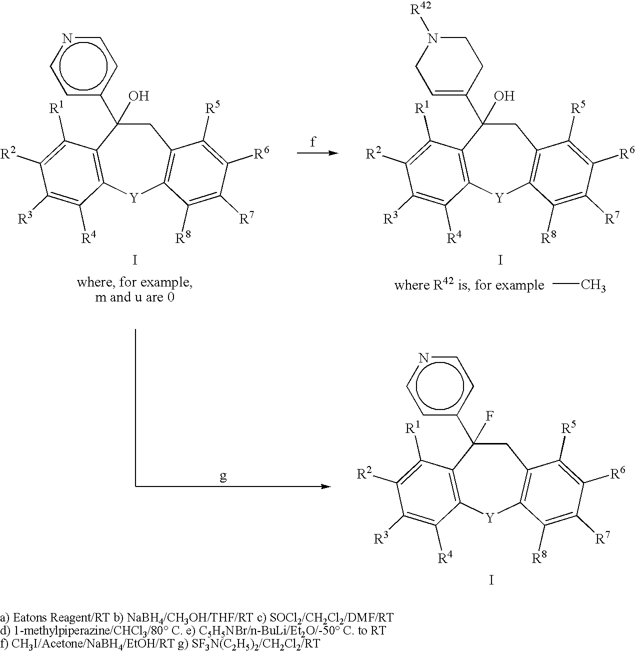
As depicted in Scheme 3, those compounds of formula I, for example, where X is —CR¹¹R¹²CR¹³R¹⁴— and Y is —O— or —S—, were again prepared in multi-step syntheses. For example, an appropriately substituted acetic acid derivative, such as 2-{2-[4-(trifluoromethoxy)phenylthio]phenyl}acetic acid, was cyclized with Eaton's Reagent affording the corresponding ketone derivative IIIa, for example, 8-(trifluoromethoxy)-11H-dibenzo[b,f]thiepan-10-one. Intermediate 1a was first reduced to the corresponding alcohol by treatment of IIIa with sodium borohydride in an appropriate solvent, then the alcohol was chlorinated with thionyl chloride, yielding the corresponding chloro derivative IIIb. The so-prepared chloride derivative IIIb, for example, 11-chloro-2-(trifluoromethoxy)-10H,11H-dibenzo[b,f]thiepane, was then converted to compounds of formula I by reacting it with an appropriate amine, for example 1-methylpiperazine, providing the compound 1-(4-methylpiperazinyl)-2-(trifluoromethoxy)-10H, 11H-dibenzo[b,f]thiopane I.

Alternatively, the ketone intermediate IIIa may be reacted directly with an appropriate base to provide additional compounds of formula I. For example, 8-(trifluoromethoxy)-11H-dibenzo[b,f]thiepan-10-one IIIa, as set forth above, may be reacted under basic conditions with halogen-containing compound, such as 4-bromopyridine, in an appropriate solvent, providing a compound of formula I, for example, 10-(4-pyridyl)-8-(trifluoromethoxy)-11H-dibenzo[b,f]thiepan-10-ol.

Any compound of formula I containing an alcohol moiety may be further reacted to prepare yet other compounds of formula I. For example, 10-(4-pyridyl)-8-(trifluoromethoxy)-11H-dibenzo[b,f]thiepan-10-ol, as set forth above, was alkylated with an alkyl halide, such as methyl iodide, then reduced with a reducing agent in an appropriate solvent, yielding the corresponding alkyl derivative, a compound of formula I, for example, 10-(1-methyl(4-1,2,5,6-tetrahydropyridyl))-8-(trifluoromethoxy)-11H-dibenzo[b,f]thiepan-10-ol I.

In yet another method, a compound of formula I containing an alcohol moiety, such as 10-(4-pyridyl)-8-(trifluoromethoxy)-11H-dibenzo[b,f]thiepan-10-ol, as set forth above, may be reacted with, for example, (diethylamino)sulfur trifluoride in an appropriate solvent, affording yet other compounds of formula I, for example, 10-fluoro-10-(4-pyridyl)-8-(trifluoromethoxy)-1H-dibenzo[b,f]thiepane.

Examples 1 through 7, inclusively, set forth below, provide in detail the methods by which compounds of formula I were prepared.

One skilled in the art will, of course, recognize that the formulation and mode of application of a toxicant may affect the activity of the material in a given application. Thus, for agricultural use the present insecticidal compounds may be formulated as a granular of relatively large particle size (for example, 8/16 or 4/8 US Mesh), as water-soluble or water-dispersible granules, as powdery dusts, as wettable powders, as emulsifiable concentrates, as aqueous emulsions, as solutions, or as any of other known types of agriculturally-useful formulations, depending on the desired mode of application. It is to be understood that the amounts specified in this specification are intended to be approximate only, as if the word “about” were placed in front of the amounts specified.

These insecticidal compositions may be applied either as water-diluted sprays, or dusts, or granules to the areas in which suppression of insects is desired. These formulations may contain as little as 0.1%, 0.2% or 0.5% to as much as 95% or more by weight of active ingredient.

Dusts are free flowing admixtures of the active ingredient with finely divided solids such as talc, natural clays, kieselguhr, flours such as walnut shell and cottonseed flours, and other organic and inorganic solids which act as dispersants and carriers for the toxicant; these finely divided solids have an average particle size of less than about 50 microns. A typical dust formulation useful herein is one containing 1.0 part or less of the insecticidal compound and 99.0 parts of talc.

Wettable powders, also useful formulations for insecticides, are in the form of finely divided particles that disperse readily in water or other dispersant. The wettable powder is ultimately applied to the locus where insect control is needed either as a dry dust or as an emulsion in water or other liquid. Typical carriers for wettable powders include Fuller's earth, kaolin clays, silicas, and other highly absorbent, readily wet inorganic diluents. Wettable powders normally are prepared to contain about 5-80% of active ingredient, depending on the absorbency of the carrier, and usually also contain a small amount of a wetting, dispersing or emulsifying agent to facilitate dispersion. For example, a useful wettable powder formulation contains 80.0 parts of the insecticidal compound, 17.9 parts of Palmetto clay, and 1.0 part of sodium lignosulfonate and 0.3 part of sulfonated aliphatic polyester as wetting agents. Additional wetting agent and/or oil will frequently be added to a tank mix for to facilitate dispersion on the foliage of the plant.

Other useful formulations for insecticidal applications are emulsifiable concentrates (ECs) which are homogeneous liquid compositions dispersible in water or other dispersant, and may consist entirely of the insecticidal compound and a liquid or solid emulsifying agent, or may also contain a liquid carrier, such as xylene, heavy aromatic naphthas, isphorone, or other non-volatile organic solvents. For insecticidal application these concentrates are dispersed in water or other liquid carrier and normally applied as a spray to the area to be treated. The percentage by weight of the essential active ingredient may vary according to the manner in which the composition is to be applied, but in general comprises 0.5 to 95% of active ingredient by weight of the insecticidal composition.

Flowable formulations are similar to ECs, except that the active ingredient is suspended in a liquid carrier, generally water. Flowables, like ECs, may include a small amount of a surfactant, and will typically contain active ingredients in the range of 0.5 to 95%, frequently from 10 to 50%, by weight of the composition. For application, flowables may be diluted in water or other liquid vehicle, and are normally applied as a spray to the area to be treated.

Typical wetting, dispersing or emulsifying agents used in agricultural formulations include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. Surface-active agents, when used, normally comprise 1 to 15% by weight of the composition.

Other useful formulations include suspensions of the active ingredient in a relatively non-volatile solvent such as water, corn oil, kerosene, propylene glycol, or other suitable solvents.

Still other useful formulations for insecticidal applications include simple solutions of the active ingredient in a solvent in which it is completely soluble at the desired concentration, such as acetone, alkylated naphthalenes, xylene, or other organic solvents. Granular formulations, wherein the toxicant is carried on relative coarse particles, are of particular utility for aerial distribution or for penetration of cover crop canopy. Pressurized sprays, typically aerosols wherein the active ingredient is dispersed in finely divided form as a result of vaporization of a low-boiling dispersant solvent carrier may also be used. Water-soluble or water-dispersible granules are free flowing, non-dusty, and readily water-soluble or water-miscible. In use by the farmer on the field, the granular formulations, emulsifiable concentrates, flowable concentrates, aqueous emulsions, solutions, etc., may be diluted with water to give a concentration of active ingredient in the range of say 0.1% or 0.2% to 1.5% or 2%.

The active insecticidal compounds of this invention may be formulated and/or applied with one or more second compounds. Such combinations may provide certain advantages, such as, without limitation, exhibiting synergistic effects for greater control of insect pests, reducing rates of application of insecticide thereby minimizing any impact to the environment and to worker safety, controlling a broader spectrum of insect pests, safening of crop plants to phytotoxicity, and improving tolerance by non-pest species, such as mammals and fish.

Second compounds include, without limitation, other pesticides, plant growth regulators, fertilizers, soil conditioners, or other agricultural chemicals. In applying an active compound of this invention, whether formulated alone or with other agricultural chemicals, an effective amount and concentration of the active compound is of course employed; the amount may vary in the range of, e.g. about 0.001 to about 3 kg/ha, preferably about 0.03 to about 1 kg/ha. For field use, where there are losses of insecticide, higher application rates (e.g., four times the rates mentioned above) may be employed.

When the active insecticidal compounds of the present invention are used in combination with one or more of second compounds, e.g., with other pesticides such as herbicides, the herbicides include, without limitation, for example: N-(phosphonomethyl)glycine (“glyphosate”); aryloxyalkanoic acids such as (2,4-dichlorophenoxy)acetic acid (“2,4-D”), (4-chloro-2-methylphenoxy)acetic acid (“MCPA”), (+/−)-2-(4-chloro-2-methylphenoxy)propanoic acid (“MCPP”); ureas such as N,N-dimethyl-N′-[4-(1-methylethyl)phenyl]urea (“isoproturon”); imidazolinones such as 2-[4,5-dihydro-4-methyl-4-(1-methylethyl)-5-oxo-1H-imidazol-2-yl]-3-pyridinecarboxylic acid (“imazapyr”), a reaction product comprising (+/−)-2-[4,5-dihydro-4-methyl-4-(1-methylethyl)-5-oxo-1H-imidazol-2-yl]-4-methylbenzoic acid and (+/−)2-[4,5-dihydro-4-methyl-4-(1-methylethyl)-5-oxo-1H-imidazol-2-yl]-5-methylbenzoic acid (“imazamethabenz”), (+/−)-2-[4,5-dihydro-4-methyl-4-(1-methylethyl)-5-oxo-1H-imidazol-2-yl]-5-ethyl-3-pyridinecarboxylic acid (“imazethapyr”), and (+/−)-2-[4,5-dihydro-4-methyl-4(1-methylethyl)-5-oxo-1H-imidazol-2-yl]-3-quinolinecarboxylic acid (“imazaquin”); diphenyl ethers such as 5-[2-chloro-4-(trifluoromethyl)phenoxy]-2-nitrobenzoic acid (“acifluorfen”), methyl 5-(2,4-dichlorophenoxy)-2-nitrobenzoate (“bifenox”), and 5-[2-chloro-4-(trifluoromethyl)phenoxy]-N-(methylsulfonyl)-2-nitrobenzamide (“fomasafen”); hydroxybenzonitriles such as 4-hydroxy-3,5-diiodobenzonitrile (“ioxynil”) and 3,5-dibromo-4-hydroxybenzonitrile (“bromoxynil”); sulfonylureas such as 2-[[[[(4-chloro-6-methoxy-2-pyrimidinyl)amino]arbonyl]amino]sulfonyl]benzoic acid (“chlorimuron”), 2-chloro-N-[[(4-methoxy-6-methyl-1,3,5-triazin-2-yl)amino]carbony]benzenesulfonamide (achlorsulfuron”), 2-[[[[[(4,6-dimethoxy-2-pyrimidinyl)amino]carbonyl]amino]sufonyl]methyl]benzoic acid (“bensulfuron”), 2-[[[[(4,6-dimethoxy-2-pyrimidinyl)amino]carbonyl]amino]sulfonyl]-1-methy-1H-pyrazol-4-carboxylic acid (“pyrazosulfuron”), 3-[[[[(4-methoxy-6-methyl-1,3,5-triazin-2-yl)amino]carbonyl]amino]sulfonyl]-2-thiophenecarboxylic acid (“thifensulfuron”), and 2-(2-chloroethoxy)-N[[(4-methoxy-6-methyl-1,3,5-triazin-2-yl)amino]carbonyl]benzenesulfonamide (“triasulfuron”); 2-(4-aryloxyphenoxy)alkanoic acids such as (+/−)-2[4-[(6-chloro-2-benzoxazolyl)oxy]phenoxy]propanoic acid (fenoxaprop”), (+/−)-2-[4[[5-(trifluoromethyl)-2-pyridinyl]oxy]phenoxy]propanoic acid (“fluazifop”), (+/−)-2-[4-(6-chloro-2-quinoxalinyl)oxy]phenoxy]propanoic acid (“quizalofop”), and (+/−) -2-[(2,4-dichlorophenoxy)phenoxy]propanoic acid (“diclofop”); benzothiadiazinones such as 3-(1-methylethyl)-1H-1,2,3-benzothiadiazin-4(3H)-one-2,2-dioxide (“bentazone”); 2-chloroacetanilides such as N-(butoxymethyl)-2-chloro-N-(2,6-diethylphenyl)acetamide (“butachlor”), 2-chloro-N-(2-ethyl-6-methylphenyl)-N-(2-menthoxy-1-methylethyl)acetamide (“metolachlor”), 2-chloro-N-(ethoxymethyl)-N-(2-ethyl-6-methylphenyl)acetamide (“acetochlor”), and (RS)-2-chloro-N-(2,4-dimethyl-3-thienyl)-N-(2-methoxy-1-methylethyl)acetamide (“dimethenamide”); arenecarboxylic acids such as 3,6-dichloro-2-methoxybenzoic acid (“dicamba”); pyridyloxyacetic acids such as [(4-amino-3,5-dichloro-6-fluoro-2-pyridinyl)oxy]acetic acid (“fluroxypyr”), and other herbicides.

When the active insecticidal compounds of the present invention are used in combination with one or more of second compounds, e.g., with other pesticides such as other insecticides, the other insecticides include, for example: organophosphate insecticides, such as chlorpyrifos, diazinon, dimethoate, malathion, parathion-methyl, and terbufos; pyrethroid insecticides, such as fenvalerate, deltamethrin, fenpropathrin, cyfluthrin, flucythrinate, alpha-cypermethrin, biphenthrin, resolved cyhalothrin, etofenprox, esfenvalerate, tralomehtrin, tefluthiin, cycloprothrin, betacyfluthrin, and acrinathrin; carbamate insecticides, such as aldecarb, carbaryl, carbofuran, and methomyl; organochlorine insecticides, such as endosulfan, endrin, heptachlor, and lindane; benzoylurea insecticides, such as diflubenuron, triflumuron, teflubenzuron, chlorfluazuron, flucycloxuron, hexaflumuron, flufenoxuron, and lufenuron; and other insecticides, such as amitraz, clofentezine, fenpyroximate, hexythiazox, spinosad, and imidacloprid.

When the active insecticidal compounds of the present invention are used in combination with one or more of second compounds, e.g., with other pesticides such as fungicides, the fungicides include, for example: benzimidazole fungicides, such as benomyl, carbendazim, thiabendazole, and thiophanate-methyl; 1,2,4-triazole fungicides, such as epoxyconazole, cyproconazole, flusilazole, flutriafol, propiconazole, tebuconazole, triadimefon, and triadimenol; substituted anilide fungicides, such as metalaxyl, oxadixyl, procymidone, and vinclozolin; organophosphorus fungicides, such as fosetyl, iprobenfos, pyrazophos, edifenphos, and tolclofos-methyl; morpholine fungicides, such as fenpropimorph, tridemorph, and dodemorph; other systemic fungicides, such as fenarimol, imazalil, prochloraz, tricyclazole, and triforine; dithiocarbamate fungicides, such as mancozeb, maneb, propineb, zineb, and ziram; non-systemic fungicides, such as chlorothalonil, dichlofluanid, dithianon, and iprodione, captan, dinocap, dodine, fluazinam, gluazatine, PCNB, pencycuron, quintozene, tricylamide, and validamycin; inorganic fungicides, such as copper and sulphur products, and other fungicides.

When the active insecticidal compounds of the present invention are used in combination with one or more of second compounds, e.g., with other pesticides such as nematicides, the nematicides include, for example: carbofuran, carbosulfan, turbufos, aldecarb, ethoprop, fenamphos, oxamyl, isazofos, cadusafos, and other nematicides.

When the active insecticidal compounds of the present invention are used in combination with one or more of second compounds, e.g., with other materials such as plant growth regulators, the plant growth regulators include, for example: maleic hydrazide, chlormequat, ethephon, gibberellin, mepiquat, thidiazon, inabenfide, triaphenthenol, paclobutrazol, unaconazol, DCPA, prohexadione, trinexapac-ethyl, and other plant growth regulators.

Soil conditioners are materials which, when added to the soil, promote a variety of benefits for the efficacious growth of plants. Soil conditioners are used to reduce soil compaction, promote and increase effectiveness of drainage, improve soil permeability, promote optimum plant nutrient content in the soil, and promote better pesticide and fertilizer incorporation. When the active insecticidal compounds of the present invention are used in combination with one or more of second compounds, e.g., with other materials such as soil conditioners, the soil conditioners include organic matter, such as humus, which promotes retention of cation plant nutrients in the soil; mixtures of cation nutrients, such as calcium, magnesium, potash, sodium, and hydrogen complexes; or microorganism compositions which promote conditions in the soil favorable to plant growth. Such microorganism compositions include, for example, bacillus, pseudoinonas, azotobacter, azospirillum, rhizobiurn, and soil-borne cyanobacteria.

Fertilizers are plant food supplements, which commonly contain nitrogen, phosphorus, and potassium. When the active insecticidal compounds of the present invention are used in combination with one or more of second compounds, e.g., with other materials such as fertilizers, the fertilizers include nitrogen fertilizers, such as ammonium sulfate, ammonium nitrate, and bone meal; phosphate fertilizers, such as superphosphate, triple superphosphate, ammonium sulfate, and diammonium sulfate; and potassium fertilizers, such as muriate of potash, potassium sulfate, and potassium nitrate, and other fertilizers.

The following examples further illustrate the present invention, but, of course, should not be construed as in any way limiting its scope. The examples are organized to present protocols for the synthesis of the compounds of formula I of the present invention, set forth a list of such synthesized species, and set forth certain biological data indicating the efficacy of such compounds.

### EXAMPLE 1

This example illustrates one protocol for the preparation of 10-(1-methyl-4-piperidylidene)benzo[b,e]thiane (Compound 2 in table below) Under a nitrogen atmosphere, 45 mL of stirred THF was cooled in an ice-water bath. To this was added 8 mL (0.008 mole) of titanium(IV) chloride (1.0M solution in toluene) via a syringe, then 1.0 gram (0.016 mole) of zinc was added in two portions during a five-minute period. After this time the reaction mixture was stirred during a ten-minute period, then a solution of 0.76 gram (0.0036 mole) of thioxanthen-9-one and 0.56 gram (0.005 mole) of 1-methyl-4-piperidone in 20 mL of THF was added drop-wise during a ten-minute period. Upon completion of addition, the reaction mixture was stirred for ten minutes, then it was heated to 60° C. where it stirred for about 20 hours. After this time, the reaction mixture was cooled and poured into 50 mL of an aqueous 10% solution of potassium carbonate. The mixture was stirred for about 20 minutes, then 50 mL of ethyl acetate was added and the mixture was stirred for an additional 20 minutes. The mixture was then filtered through a pad of diatomaceous earth, and the diatomaceous earth pad was washed with 50 mL of ethyl acetate. The combined ethyl acetate from the wash and from the filtrate was separated, and the aqueous phase was extracted with 20 mL of ethyl acetate. The combined ethyl acetate fractions were then washed with an aqueous solution saturated with sodium bicarbonate and dried with sodium sulfate. The mixture was filtered and the filtrate concentrated under reduced pressure to a solid residue. The residue was purified with column chromatography on aluminum oxide (neutral activated III) using mixtures of heptane and ethyl acetate as eluant. The appropriate fractions were combined and concentrated under reduced pressure, yielding 0.25 gram of the Compound 2. The NMR spectrum was consistent with the proposed structure.

### EXAMPLE 2

This example illustrates one protocol for the preparation of 9-(1-methyl-4-piperidylidene)xanthene (Compound 8 in table below)

### Step A Synthesis of 9-(1-phenylmethyl-4-piperidylidene)xanthene as an intermediate

This compound was prepared in a manner analogous to that set forth in Example 1, by the reaction of 0.78 gram (0.004 mole) of xanthone, 0.95 gram (0.005 mole) of 1-phenylmethyl-4-piperidone, 1.6 grams (0.024 mole) of zinc, and 12 mL (0.012 mole) of titanium(IV) chloride (1.0M solution in toluene) in 70 mL of THF. The yield of the subject compound was 1.4 grams. The NMR spectrum was consistent with the proposed structure.

### Step B Synthesis of 9-[1-(2,2,2-trichloroethoxycarbonyl)-4-piperidylidene]xanthene as an intermediate

Under a nitrogen atmosphere, a solution of 0.7 gram (0.002 mole) of 9-(1-phenylmethyl-4-piperidylidene)xanthene in 50 mL of 1:2 chloroform: acetonitrile was stirred, and 0.85 gram (0.004 mole) of 2,2,2-trichloroethyl chloroformate was added in one portion via a syringe. Upon completion of addition, the reaction mixture was warmed to reflux where it stirred for one hour, then the reaction mixture was cooled to ambient temperature where it stirred for about 18 hours. After this time the reaction mixture was poured into 50 mL of water and extracted with two 40 mL portions of ethyl acetate. The combined extracts were then washed with an aqueous solution saturated with sodium chloride and dried with sodium sulfate. The mixture was filtered and the filtrate was concentrated under reduced pressure to a residual oil. The oil was dissolved in 20 mL of methanol, to which was added 5 mL of water. The mixture was cooled in an ice-water bath, and a solid precipitate formed. The solid was collected by filtration and dried under vacuum, yielding 0.73 gram of the subject compound, mp 132-134° C. The NMR spectrum was consistent with the proposed structure.

### Step C Synthesis of 9-(1-methoxycarbonyl-4-piperidylidene)xanthene as an intermediate

A stirred solution of 0.6 gram (0.0013 mole) of 9-[1-(2,2,2-trichloroethoxycarbonyl)-4-piperidylidene]xanthene, 0.25 gram (0.0062 mole) of sodium hydroxide, and 2 mL of water in 20 mL of methanol was warmed to reflux where it stirred for six hours. After this time the reaction mixture was cooled to ambient temperature where it stirred for about 18 hours. The reaction mixture was then concentrated under reduced pressure to remove the majority of the methanol, and 30 mL of an aqueous solution saturated with sodium bicarbonate was added. The mixture was extracted with two 20 mL portions of ethyl acetate and the combined extracts were dried with sodium sulfate. The mixture was filtered and the filtrate was concentrated under reduced pressure to an oil residue. The residue was purified with column chromatography on silica using 5:1 heptane:ethyl acetate as eluant. The appropriate fractions were combined and concentrated under reduced pressure, yielding 0.28 gram of the subject compound. The NMR spectrum was consistent with the proposed structure.

Note: The intended intermediate of Step C in the above preparative example was 9-(4-piperidylidene)xanthene.

### Step D Synthesis of Compound 8

Under a nitrogen atmosphere a solution of 0.28 gram (0.0008 mole) of 9-(1-methoxycarbonyl-4-piperidylidene)xanthene in 20 mL of THF was stirred, and 3 mL of lithium aluminum hydride (1.0M in THF) was added via a syringe during a ten minute period. After this time the reaction mixture was warmed to 40° C. where it stirred for two hours. The reaction mixture was then cooled and 20 mL of aqueous 0.5N sodium hydroxide was added in one portion. The mixture was extracted with two 40 mL portions of ethyl acetate, and the combined extracts were washed with 20 mL of an aqueous solution saturated with sodium bicarbonate. The extracts were dried with sodium sulfate and filtered. The filtrate was concentrated under reduced pressure, yielding 0.2 gram of Compound 5. The NMR spectrum was consistent with the proposed structure.

### EXAMPLE 3

This example illustrates one protocol for the preparation of 2-(methylethyl)-11-(4-methylpiperazinyl)dibenzo[b,f]1,4-thiazepine (Compound 193 in table below)

### Step A Synthesis of 2-[4-(methylethyl)phenylthio]benzenisocyanate as an intermediate

Under a nitrogen atmosphere a solution of 1.2 grams (0.0049 mole) of 2-[4-(methylethyl)phenylthio]phenylamine (known compound) in 60 mL of ethyl acetate was stirred, and 2.2 grams (0.011 mole) of trichloromethyl chlorooate was added by pipette in one portion. Upon completion of addition the reaction mixture was heated to reflux where it stirred for three hours. After this time the reaction mixture was cooled and concentrated under reduced pressure to a residue. The residue was further dried under vacuum, yielding 1.5 grams of the subject compound. The NMR spectrum was consistent with the proposed structure.

### Step B Synthesis of 2-(methylethyl)-10-dibenzo[b,f]-1,4-thiazaperhydroepin-11-one as an intermediate

Under a nitrogen atmosphere a stirred mixture of 1.0 gram (0.0075 mole) of aluminum chloride in five mL of chlorobenzene was warmed to 80° C., and a solution of 1.4 grams (0.0052 mole) of 2-[4-(methylethyl)phenylthio]benzenisocyanate in one mL of chlorobenzene was added dropwise during a one minute period. Upon completion of addition the reaction mixture was warmed to 110° C. where it stirred for two hours. After this time the reaction mixture was cooled and poured into water. The mixture was extracted with two 40 mL portions of ethyl acetate, and the extracts were combined. The combined extracts were then washed with an aqueous solution saturated with sodium chloride, dried with sodium sulfate, filtered; and the filtrate was concentrated under reduced pressure to a residue. The residue was purified with column chromatography on silica using 5:1 and 3:1 mixtures of heptane:ethyl acetate as eluants. The appropriate fractions were combined and concentrated under reduced pressure, yielding 0.65 gram of the subject compound. The NMR spectrum was consistent with the proposed structure.

### Step C Synthesis of 1]-chloro-2-(methylethyl)dibenzo[b,f]1,4-thiazepine as an intermediate

Under a nitrogen atmosphere a solution of 0.62 gram (0.0023 mole) of 2-(methylethyl)-10-dibenzo[b,f]-1,4-thiazaperhydroepin-11-one in 10 mL of phosphorous oxychloride was stirred and 5 drops of diethylphenylamine was added. Upon completion of addition the reaction mixture was heated to reflux where it stirred for 3.5 hours. The reaction mixture was then concentrated under reduced pressure to remove the majority of the phosphorous oxychloride, and the residue was poured into 50 mL of ice-water. The mixture was then extracted three 30 mL portions of diethyl ether. The combined extracts were washed with an aqueous solution saturated with sodium chloride, dried with sodium sulfate, filtered; and the filtrate was concentrated under reduced pressure, yielding 0.55 gram of the subject compound. The NMR spectrum was consistent with the proposed structure.

### Step D Synthesis of Compound 193

Under a nitrogen atmosphere a stirred solution of 0.24 gram (0.0008 mole) of 11-chloro-2-(methylethyl)dibenzo[b,f]1,4-thiazepine and 0.4 mL (0.0036 mole) of 1-methylpiperazine in 25 mL of xylenes was heated to reflux where it stirred for two hours. After this time the reaction mixture was cooled ambient temperature and poured into 25 mL of diethyl ether. The mixture was then extracted with three 20 mL portions of aqueous 3N hydrochloric acid. The aqueous extracts were combined and washed with 20 mL of diethyl ether, made basic with aqueous 10% potassium carbonate; then extracted with three 20 mL portions of diethyl ether. The ether extracts were combined, dried with sodium sulfate, filtered and concentrated under reduced pressure to a residue. The residue was purified with column chromatography on silica using methylene chloride, 1% methanol in methylene chloride, and 3% methanol in methylene chloride as eluants. The appropriate fractions were combined and concentrated under reduced pressure, yielding 0.21 gram of Compound 193. The NMR spectrum was consistent with the proposed structure.

### EXAMPLE 4

This example illustrates one protocol for the preparation of 11-(4-methylpiperazinyl)-2-(trifluoromethoxy)-10H, 11H-dibenzo[b,f]thiopane (Compound 106 in table below)

### Step A Synthesis of 2-{2-[4-(trifluoromethoxy)phenylthio]phenyl}acetic acid as an intermediate

A mixture of 26.2 grams (0.47 mole) of potassium hydroxide and 1.1 grams (0.018 mole) of powdered copper (catalyst) in 200 mL of water was stirred, and 30.6 grams (0.117 mole) of 2-iodophenylacetic acid and 22.7 grams (0.117 mole) of 4-trifluoromethoxyphenol were added. Upon completion of addition the reaction mixture was warmed to reflux where it stirred for about 18 hours. After this time the reaction mixture was cooled to ambient temperature and filtered. The filtrate was poured into 500 mL of aqueous 10% hydrochloric acid and the mixture was extracted with three 250 mL portions of ethyl acetate. The combined extracts washed with an aqueous solution saturated with sodium chloride, dried with sodium sulfate, filtered, and concentrated under reduced pressure, yielding 39.6 grams of the subject compound.

### Step B Synthesis of 8-(trifluoromethoxy)-11H-dibenzo[b,f]thiepan-10-one as an intermediate

A mixture of 10.0 grams (0.0304 mole) of 2-{2-[4-(trifluoromethoxy)phenylthio]phenyl}acetic acid in 75 mL of Eatons Reagent was stirred for an 18 hour period during which time complete solution was obtained. After this time the reaction mixture was poured into ice-water and extracted with four 150 mL portions of ethyl acetate. The combined extracts were then washed with one portion of a aqueous dilute solution of sodium bicarbonate and with one portion of an aqueous solution saturated with sodium chloride. The organic layer was dried with sodium sulfate, filtered and concentrated under reduced pressure to a residue. The residue was purified with column chromatography on silica using 1:2 ethyl acetate:hexane as an eluant. The appropriate fractions were combined and concentrated under reduced pressure, yielding 4.0 grams of the subject compound. The NMR spectrum was consistent with the proposed structure. Step C Synthesis of 11-chloro-2-(trifluoromethoxy)-10H,11H-dibenzo[b,f]thiepane as an intermediate

A solution of 2.3 grams (0.0073 mole) of 8-(trifluoromethoxy)-11H-dibenzo[b,f]thiepan-10-one in a mixture of 5 mL of THF and 30 mL of methanol was stirred and 0.4 gram of sodium borohydride was added. The reaction mixture was then stirred at ambient temperature during a two hour period. After this time the reaction mixture was poured into 100 mL of aqueous 10% hydrochloric acid, to which was then added 300 mL of an aqueous solution saturated with sodium chloride. The mixture was extracted with three 100 mL portions of ethyl acetate. The combined extracts were dried with sodium sulfate, filtered and the filtrate concentrated under reduced pressure to a residue. In an effort to further dry the residue, it was dissolved in 50 mL of methylene chloride and the mixture was concentrated under reduced pressure to a residue. The drying process was repeated two additional times, yielding a dried residue. The residue was again dissolved in 50 mL of methylene chloride and 3 mL of thionyl chloride was added. The reaction mixture was stirred at ambient temperature during a 2.5 hour period. After this time the reaction mixture was concentrated under reduced pressure, yielding 2.0 grams of the subject compound.

### Step D Synthesis of Compound 106

A solution of 1.0 gram (0.0030 mole) of 11-chloro-2-(trifluoromethoxy)-10H,11H-dibenzo[b,f]thiepane was dissolved in 5 mL of chloroform and placed in a sealable tube, followed by 1.2 grams (0.0119 mole) of 1-methylpiperazine. The sealable tube was then sealed and the tube and contents were heated at 80° C. during an 18 hour period. The reaction mixture was taken from the tube and purified with column chromatography on silica using methylene chloride, then ethyl acetate as eluants. The appropriate fractions were combined and concentrated under reduced pressure, yielding 0.6 gram of Compound 106. The NMR spectrum was consistent with the proposed structure.

### EXAMPLE 5

This example illustrates one protocol for the preparation of 10-(4-pyridyl)-8-(trifluoromethoxy)-11H-dibenzo[b,f]thiepan-10-ol (Compound 61 in table below)

An aliquot of 1.0 gram (0.0051 mole) of 4-bromopyridine hydrochloride was stirred for 20 minutes with 20 mL of an aqueous solution saturated with sodium bicarbonate. The mixture was then extracted with two 20 mL portions of methylene chloride. The combined extracts were dried with sodium sulfate, filtered and concentrated under reduced pressure, providing 0.5 gram of the free pyridine.

Under a nitrogen atmosphere, about 0.4 grams of the free pyridine was dissolved in 40 mL of diethyl ether and cooled to about −50° C. in a dry ice-acetonitrile bath. To this cold solution was added by syringe 1.0 mL (0.0025 mole) of 2.5 M n-butyllithium (in hexanes) while maintaining the reaction mixture temperature at −45° C. or below. Upon completion of addition the reaction mixture was stirred for 30 minutes at −50° C., then 0.6 gram (0.0020 mole) of 8-(trifluoromethoxy)-11H-dibenzo[b,f]thiepan-10-one (prepared in Step B of Example 4) was added in one portion. Upon completion of addition the reaction mixture was allowed to warm to ambient temperature as it stirred during a 1.5 hour period. After this time the reaction mixture was poured into 50 mL of water and the organic layer was separated. The aqueous layer was extracted with two 30 mL portions of diethyl ether. The extracts and the organic layer were combined and washed with an aqueous solution saturated with sodium chloride. The combination was then dried with sodium sulfate, filtered and the filtrate was concentrated under reduced pressure to a residue. The residue was purified with column chromatography on silica using 3:1 heptane:ethyl acetate, then 1:1 heptane:ethyl acetate as eluants. The appropriate fractions were combined and concentrated under reduced pressure, yielding 0.6 gram of Compound 61. The NMR spectrum was consistent with the proposed structure. This reaction was repeated several times.

### EXAMPLE 6

This example illustrates one protocol for the preparation of 10-(1-methyl(4-1,2,5,6-tetrahydropyridyl))-8-(trifluoromethoxy)-11H-dibenzo[b,f]thiepan-10-ol (Compound 215 in table below)

A solution of 0.55 gram (0.0014 mole) of 10-(4-pyridyl)-8-(trifluoromethoxy)-11H-dibenzo[b,f]thiepan-10-ol (prepared in Example 5) and 0.43 gram (0.0030 mole) of methyl iodide in 60 mL of acetone was stirred in a stoppered reaction vessel for about 18 hours. After this time the reaction mixture was analyzed by thin layer chromatography (TLC), which indicated some unreacted thiepan-10-ol. An additional 0.43 gram of methyl iodide was added to the reaction mixture, and stirring was continued for an additional 24 hours. After this time the reaction mixture was concentrated under reduced pressure to a residual solid, which was triturated with petroleum ether and dried. The solid was dissolved in 40 mL of ethanol and, with stirring, 0.45 gram (0.012 mole) of sodium borohydride was added. Upon completion of addition the reaction mixture was during a three hour period. After this time the reaction mixture was poured into 75 mL of aqueous 1% sodium bicarbonate. The mixture was then extracted with three 20 mL portions of ethyl acetate. The combined extracts were washed with an aqueous solution saturated with sodium chloride, then dried with sodium sulfate, filtered, and concentrated under reduced pressure, yielding 0.40 gram of Compound 215. The NMR spectrum was consistent with the proposed structure.

### EXAMPLE 7

This example illustrates one protocol for the preparation of 10-fluoro-10-(4-pyridyl)-8-(trifluoromethoxy)-11H-dibenzo[b,f]thiepane (Compound 216 in table below)

Under a nitrogen atmosphere a solution of 0.12 gram (0.0003 mole) of 10-(4-pyridyl)-8-(trifluoromethoxy)-11H-dibenzo[b,f]thiepan-10-ol (prepared in Example 5) in 10 mL of methylene chloride was stirred and 0.12 gram (0.0008 mole) of (diethylamino)sulfur trifluoride was added by syringe. Upon completion of addition the reaction mixture was stirred for a 20 minute period, then it was poured into 30 mL of an aqueous dilute solution of sodium bicarbonate. The organic layer was separated and the aqueous layer was extracted with 25 mL of methylene chloride. The extract and the organic layer were combined and washed with an aqueous solution saturated with sodium chloride. The combination was then dried with sodium sulfate, filtered, and the filtrate was concentrated under reduced pressure to a residue. The residue was purified with column chromatography on alumina (Neutral, Activity III) using 5:1 heptane:ethyl acetate as an eluant. The appropriate fractions were combined and concentrated under reduced pressure, yielding 0.1 gram of Compound 216. The NMR spectrum was consistent with the proposed structure.

It is well known to one of ordinary skill in the art that compounds like the compounds of formula I of the present invention can contain optically active and racemic forms. It is also well known in the art that compounds like the compounds of formula I may contain stereoisomeric forms, tautomeric forms and/or exhibit polymorphism. It is to be understood that the present invention encompasses any racemic, optically active, polymorphic, tautomeric, or stereoisomeric form, or mixtures thereof. It should be noted that it is well known in the art how to prepare optically active forms, for example by resolution of a racemic mixture, or by synthesis from optically active intermediates.

The following table sets forth some additional examples of compounds of formula I useful in the present invention:

TABLE 1
Insecticidal Phenothiazines, Phenoxazines, Dihydrophenazines,
Dibenzothiepins, Dibenzooxepins, Dibenzoazepines

| | |
|---|---|
| | I |
| 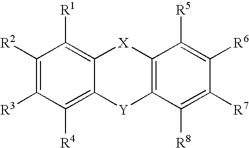 | |

Where X is —CR⁹R¹⁰—, R⁹ and R¹⁰ taken together is

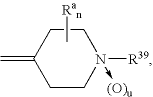

where u is 0, and R^{a} is hydrogen; R¹ and R⁵ through R⁸,
inclusively, are hydrogen:

| Cmpd. | | | | | | | | |
|---|---|---|---|---|---|---|---|---|
| No. | Y | R³⁰ | R² | R³ | R⁴ | R³⁹ | R^{a} | n |
| 1 | S | — | H | H | H | H | H | 0 |
| 2 | S | — | H | H | H | CH₃ | H | 0 |
| 3 | S | — | H | H | H | CH(CH₃)₂ | H | 0 |
| 4 | S | — | Cl | H | H | CH₃ | H | 0 |
| 5 | S | — | CF₃ | H | H | CH₃ | H | 0 |
| 6 | S | — | SCH₃ | H | H | CH₃ | H | 0 |
| 7 | S | — | H | H | H | CH₂C≡N | H | 0 |
| 8 | O | — | H | H | H | CH₃ | H | 0 |
| 9 | O | — | F | H | H | CH₃ | H | 0 |
| 10 | O | — | H | F | H | CH₃ | H | 0 |
| 11 | O | — | H | H | F | CH₃ | H | 0 |
| 12 | O | — | C₂H₅ | H | H | CH₃ | H | 0 |
| 13 | O | — | OC₂H₅ | H | H | CH₃ | H | 0 |
| 14 | O | — | C₂H₄OCH₃ | H | H | CH₃ | H | 0 |
| 15 | O | — | CF₃ | H | H | CH₃ | H | 0 |
| 16 | O | — | H | OCF₃ | H | CH₃ | H | 0 |
| 17 | O | — | Cl | H | H | CH₂Ph | H | 0 |
| 18 | O | — | CF₃ | H | H | CH₂Ph | H | 0 |
| 19 | O | — | SCH₃ | H | H | CH₂Ph | H | 0 |
| 20 | O | — | H | H | H | C₂H₄CO₂C₂H₅ | H | 0 |
| 21 | O | — | H | H | H | CH₃ | 2-CH₃ | 1 |
| 22 | O | — | H | H | H | CH₃ | 3-CH₃ | 1 |
| 23 | NR³⁰ | H | H | H | H | CH₃ | H | 0 |
| 24 | NR³⁰ | CH₃ | H | H | H | CH₃ | H | 0 |
| 25 | NR³⁰ | CH₃ | CF₃ | H | H | CH₃ | H | 0 |

where X is —CR⁹R¹⁰—; Y is —CR³⁴R³⁵O—, and R¹, R³, R⁴, R⁵,
R⁷, R⁸, R³⁴, R³⁵ are hydrogen; n is 0, and R^{a} is hydrogen:

| | | | | | | | |
|---|---|---|---|---|---|---|---|
| Cmpd. | | | | | | | |
| No. | R² | R⁶ | R⁹ | R¹⁰ | R³⁹ | R⁴⁰ | R⁴¹ |

| | | | | | | |
|---|---|---|---|---|---|---|
| 26⁶ | H | H | 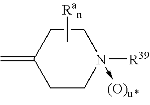 | CH₃ | — | — |
| 27 | H | CF₃ | 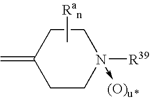 | CH₃ | — | — |
| 28 | H | CF₃ | 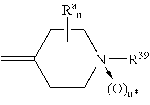 | C₂H₄CO₂C₂H₅ | — | — |
| 29² | Cl | H | ═CHC₂H₄NR⁴⁰R⁴¹ | — | CH₃ | CH₃ |
| 30⁶ | H | Cl | ═CHC₂H₄NR⁴⁰R⁴¹ | — | CH₃ | CH₃ |
| 31 | H | Cl | ═CHC₂H₄NR⁴⁰R⁴¹ | — | H | CH(CH₃)₂ |
| 32² | OCH₃ | H | ═CHC₂H₄NR⁴⁰R⁴¹ | — | CH₃ | CH₃ |
| 33⁶ | H | OCH₃ | ═CHC₂H₄NR⁴⁰R⁴¹ | — | CH₃ | CH₃ |
| 34⁶ | H | SCH₃ | ═CHC₂H₄NR⁴⁰R⁴¹ | — | CH₃ | CH₃ |
| 35⁶ | H | S(O)₂N(CH₃)₂ | ═CHC₂H₄NR⁴⁰R⁴¹ | — | CH₃ | CH₃ |

| | | | | | |
|---|---|---|---|---|---|
| 36⁷ | H | SCH₃ | ═CHC₂H₄NR⁴⁰R⁴¹ | — | —C₂H₄N(CH₃)C₂H₄— |

*where u is 0

where X is —CR⁹R¹⁰—; Y is —CR³⁶R³⁷S—, and R¹ through R⁵, inclusively,
R⁷, R⁸, R³⁶, and R³⁷ are hydrogen; n is 0 and R^{a} is hydrogen:

| | | | | | | |
|---|---|---|---|---|---|---|
| Cmpd. | | | | | | |
| No. | R⁶ | R⁹ | R¹⁰ | R³⁹ | R⁴⁰ | R⁴¹ |

| | | | | | |
|---|---|---|---|---|---|
| 37 | H | 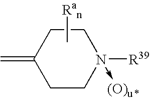 | CH₃ | — | — |
| 38 | CF₃ | 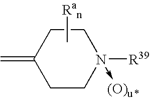 | CH₃ | — | — |
| 39 | H | ═CHC₂H₄NR⁴⁰R⁴¹ | — | CH₃ | CH₃ |

where u is 0

where X is —CR⁹R¹⁰—; Y is —CR³¹R³²NR³³—,
where R¹ through R⁸, inclusively,
and R³¹and R³² are hydrogen; and n is 0 and R^{a} is hydrogen:

| Cmpd. | | | | | | |
|---|---|---|---|---|---|---|
| No. | R⁹ | R¹⁰ | R³⁹ | R⁴⁰ | R⁴¹ | R³³ |
| 40 | H | 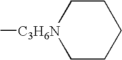 | — | — | — | CH₃ |

| | | | | | |
|---|---|---|---|---|---|
| 41 | 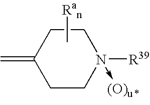 | CH₃ | — | — | CH₃ |
| 42 | ═CHC₂H₄NR⁴⁰R⁴¹ | — | CH₃ | CH₃ | CH₃ |

where u is 0

where X is —CR⁹R¹⁰—; Y is —CR³⁸═N—, and R¹, R³ through R⁸,
inclusively, and R³⁸ are hydrogen; n is 0 and R^{a} is hydrogen:

| | | | | | | |
|---|---|---|---|---|---|---|
| Cmpd. | | | | | | |
| No. | R² | R⁹ | R¹⁰ | R³⁹ | R⁴⁰ | R⁴¹ |

| | | | | | |
|---|---|---|---|---|---|
| 43 | H | 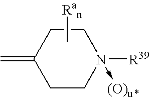 | CH₃ | — | — |
| 44 | CF₃ | 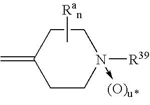 | CH₃ | — | — |
| 45 | CF₃ | 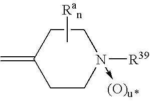 | C₂H₄CO₂C₂H₅ | — | — |
| 46 | H | ═CHC₂H₄NR⁴⁰R⁴¹ | — | CH₃ | CH₃ |
| 47 | Cl | ═CHC₂H₄NR⁴⁰R⁴¹ | — | CH₃ | CH₃ |
| 48 | H | ═CHC₂H₄NR⁴⁰R⁴¹ | — | CH₃ | CH₃ |
| 49 | OCH₃ | ═CHC₂H₄NR⁴⁰R⁴¹ | — | CH₃ | CH₃ |
| 50 | SCH₃ | ═CHC₂H₄NR⁴⁰R⁴¹ | — | CH₃ | CH₃ |
| 51 | S(O)₂N(CH₃)₂ | ═CHC₂H₄NR⁴⁰R⁴¹ | — | CH₃ | CH₃ |

*where u is 0

where X is —CR¹¹R¹²CR¹³R¹⁴—; where R¹, R³ through R⁸,
inclusively, R¹³, and R¹⁴ are hydrogen, n and m are 0 and R^{a} and R^{b} are
hydrogen, and when it is noted that v is 1, then A is —O—:

| Cmpd. | | | | | | |
|---|---|---|---|---|---|---|
| No. | R² | R¹¹ | R¹² | Y | R³⁹ | R⁴² |
| 52 | OCF₃ | OC₂H₄N(C₂H₅)₂ | H | S | — | — |
| 53 | SCH₃ | NHC₃H₆OC₂H₅ | H | S | — | — |
| 54 | SCH₃ | N(CH₃)C₂H₄N(CH₃)₂ | H | S | — | — |
| 55 | SCH₃ | morpholin-4-yl | H | S | — | — |
| 56 | SCH₃ | 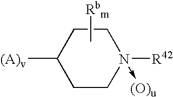 | H | S | — | CH₃ |
| Cmpd. | | | | | | |
| No. | R² | R¹¹ | R¹² | Y | R³⁹ | R⁴² |
| 57 | SCH₃ | 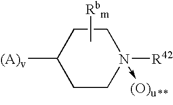 | H | S | — | CH₃ |
| 58 | Cl | imidazolin-2-yl | H | O | — | — |
| 59 | OCF₃ | 1-methylpyrrolidin-3-yloxy | H | S | — | — |
| 60 | OCF₃ | C≡CHCH₂N(CH₃)₂ | OH | S | — | — |
| 61 | OCF₃ | 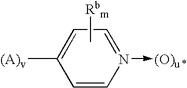 | OH | S | — | — |

| | | | | | |
|---|---|---|---|---|---|
| 62 | OCF₃ | 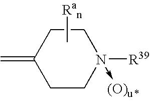 | S | CH₃ | — |

*where u is 0
**where v is 1

where X is —CR¹¹R¹²CR¹³R¹⁴—; where R¹², R¹³, and R¹⁴ are hydrogen; and

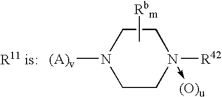

where v is 0; m is 0 and R^{b} is hydrogen; R⁴² is —CH₃; and unless otherwise
noted u is 0:

| Cmpd. | | | | | | | | | | | | |
|---|---|---|---|---|---|---|---|---|---|---|---|---|
| No. | R¹ | R² | R³ | R⁴ | R⁵ | R⁶ | R⁷ | R⁸ | Y | R²² | R²³ | R³⁰ |
| 63 | H | H | H | H | H | H | H | H | O | — | — | — |
| 64 | H | Cl | H | H | H | H | H | H | O | — | — | — |
| 65 | H | Br | H | H | H | H | H | H | O | — | — | — |
| 66 | H | F | H | H | H | H | H | H | O | — | — | — |
| 67 | H | I | H | H | H | H | H | H | O | — | — | — |
| 68 | H | CH₃ | H | H | H | H | H | H | O | — | — | — |
| 69 | H | CF₃ | H | H | H | H | H | H | O | — | — | — |
| 70 | H | SCH₃ | H | H | H | H | H | H | O | — | — | — |
| 71 | H | OCF₃ | H | H | H | H | H | H | O | — | — | — |
| 72^{a} | H | OCF₃ | H | H | H | H | H | H | O | — | — | — |
| 73 | H | H | OCF₃ | H | H | H | H | H | O | — | — | — |
| 74^{a} | H | H | OCF₃ | H | H | H | H | H | O | — | — | — |
| 75 | H | SCF₃ | H | H | H | H | H | H | O | — | — | — |
| 76 | H | S(O)CF₃ | H | H | H | H | H | H | O | — | — | — |
| 77 | H | S(O)₂CF₃ | H | H | H | H | H | H | O | — | — | — |
| 78 | H | —CH═CH₂ | H | H | H | H | H | H | O | — | — | — |
| 79 | H | —C≡CH | H | H | H | H | H | H | O | — | — | — |
| 80 | H | —C≡CSi(CH₃)₃ | H | H | H | H | H | H | O | — | — | — |
| 81 | H | NO₂ | H | H | H | H | H | H | O | — | — | — |
| 82 | H | Cl | Cl | H | H | H | H | H | O | — | — | — |
| 83 | H | Cl | H | Cl | H | H | H | H | O | — | — | — |
| 84 | H | Cl | F | H | H | H | H | H | O | — | — | — |
| 85 | H | Cl | H | F | H | H | H | H | O | — | — | — |
| 86 | H | F | Cl | H | H | H | H | H | O | — | — | — |
| 87 | H | F | H | Cl | H | H | H | H | O | — | — | — |
| 88 | H | Br | H | F | H | H | H | H | O | — | — | — |
| 89 | H | Br | H | CH₃ | H | H | H | H | O | — | — | — |
| 90² | H | H | H | H | H | H | H | H | S | — | — | — |
| 91² | H | H | Cl | H | H | H | H | H | S | — | — | — |
| 92 | H | H | Cl | H | H | Cl | H | H | S | — | — | — |
| 93 | F | H | H | H | H | H | H | H | S | — | — | — |
| 94 | H | H | H | F | H | H | H | H | S | — | — | — |
| 95 | H | Cl | F | H | H | H | H | H | S | — | — | — |
| 96⁸ | H | Cl | H | F | H | H | H | H | S | — | — | — |
| 97 | F | H | H | F | H | H | H | H | S | — | — | — |
| 98⁹ | H | C₂H₅ | H | H | H | H | H | H | S | — | — | — |
| 99 | H | C(CH₃)₃ | H | H | H | H | H | H | S | — | — | — |
| 100 | H | OCH₃ | H | H | H | H | H | H | S | — | — | — |
| 101 | H | H | OCH₃ | H | H | H | H | H | S | — | — | — |
| 102 | H | H | H | OCH₃ | H | H | H | H | S | — | — | — |
| 103² | H | SCH₃ | H | H | H | H | H | H | S | — | — | — |
| 104⁸ | H | SC₂H₅ | H | H | H | H | H | H | S | — | — | — |
| 105 | H | CF₃ | H | H | H | H | H | H | S | — | — | — |
| 106 | H | OCF₃ | H | H | H | H | H | H | S | — | — | — |
| 107^{a} | H | OCF₃ | H | H | H | H | H | H | S | — | — | — |
| 108 | H | OCF₃ | H | H | H | H | F | H | S | — | — | — |
| 109 | H | OCF₂CHF₂ | H | H | H | H | H | H | S | — | — | — |
| 110² | H | H | Cl | Cl | H | H | H | H | S | — | — | — |
| 111 | H | CH₃ | F | H | H | H | H | H | S | — | — | — |
| 112 | c-C₃H₅ | H | H | H | H | H | H | H | S | — | — | — |
| 113 | H | c-C₅H₉ | H | H | H | H | H | H | S | — | — | — |
| 114 | H | NH₂ | H | H | H | H | H | H | S | — | — | — |
| 115 | H | C(═O)CH₃ | H | H | H | H | H | H | S | — | — | — |
| 116 | H | H | H | H | F | H | H | H | S | — | — | — |
| 117¹⁰ | H | H | H | H | F | H | H | H | S | — | — | — |
| 118 | H | H | H | H | H | F | H | H | S | — | — | — |
| 119 | H | H | H | H | H | H | F | H | S | — | — | — |
| 120 | H | H | H | H | H | H | H | F | S | — | — | — |
| 121 | H | Cl | H | H | H | F | H | H | S | — | — | — |
| 122 | H | SCH₃ | H | H | H | F | H | H | S | — | — | — |
| 123 | H | SCH₃ | H | H | H | H | F | H | S | — | — | — |
| 124 | H | SC₂H₅ | H | H | H | H | F | H | S | — | — | — |
| 125⁴ | H | CF₃ | H | H | H | H | F | H | S | — | — | — |
| 126 | H | OCF₃ | H | H | H | H | F | H | S | — | — | — |
| 127 | H | CH(CH₃)₂ | H | H | H | H | F | H | S | — | — | — |
| 128² | H | CH(CH₃)₂ | H | H | H | H | F | H | S | — | — | — |
| 129 | H | CH(CH₃)₂ | H | H | H | H | F | H | S(O) | — | — | — |
| 130 | H | H | H | H | H | H | H | H | CR²²R²³ | H | H | — |
| 131 | H | OCF₃ | H | H | H | H | H | H | CR²²R²³ | H | H | — |
| 132 | H | H | H | H | H | H | H | H | NR³⁰ | — | — | H |
| 133 | H | F | H | H | H | H | H | H | NR³⁰ | — | — | H |
| 134 | H | CF₃ | H | H | H | H | H | H | NR³⁰ | — | — | H |
| 135 | H | SCH₃ | H | H | H | H | H | H | NR³⁰ | — | — | H |
| 136 | H | OCF₃ | H | H | H | H | H | H | NR³⁰ | — | — | H |
| 137 | H | H | H | H | H | H | H | H | NR³⁰ | — | — | CH₃ |

^{a}u is 1, forming an N-oxide

where X is —CR¹¹R¹²CR¹³R¹⁴—; where R¹², R¹³, and R¹⁴ are hydrogen; and

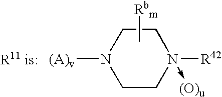

where v is 0; m is 0 and R^{b} is hydrogen; R³, R⁴, and R⁸ are hydrogen;
and unless otherwise noted u is 0;

| Cmpd. | | | | | | | |
|---|---|---|---|---|---|---|---|
| No. | R¹ | R² | R⁵ | R⁶ | R⁷ | Y | R⁴² |
| 138 | H | OCF₃ | H | H | H | O | H |
| 139 | H | OCF₃ | H | H | H | O | C₂H₅ |
| 140 | H | OCF₃ | H | H | H | O | C(═O)CH₃ |
| 141 | H | SCH₃ | H | H | H | O | 2-piperidinylethylamino |
| 142 | H | H | F | H | H | S | C₂H₅ |
| 143 | H | OCF₃ | H | H | H | S | H |
| 144 | H | OCF₃ | H | H | H | S | C₂H₅ |
| 145 | H | OCF₃ | H | H | H | S | CH₂CH═CH |
| 146 | H | SCH₃ | H | H | H | S | C₂H₅ |
| 147¹⁰ | H | H | F | H | H | S | C₂H₅ |
| 148 | H | H | H | H | H | S | C≡N |
| 149⁹ | H | Cl | H | H | H | S | C≡N |
| 150 | H | CF₃ | H | H | F | S | C₂H₄OH |
| 151 | H | S(O)CH₃ | H | H | F | S | C₂H₄OH |
| 152 | H | OCH₃ | H | H | H | S | C₃H₆OH |
| 153⁴ | H | SCH₃ | H | H | F | S | C₃H₆OH |
| 154² | H | Cl | H | H | H | S | C₂H₄OC₂H₅ |
| 155 | H | SCH₃ | H | H | H | S | CH₂CH(OH)C₂H₅ |
| 156 | H | OCF₃ | H | H | H | S | C₂H₄OCH₃ |
| 157 | H | OCF₃ | H | H | H | S | C₂H₄OC₂H₅ |
| 158 | H | SCH₃ | H | H | H | S | C₂H₄Ophenyl |
| 159² | H | H | H | Cl | H | S | C₂H₄Ophenyl |
| 160 | H | Cl | H | H | H | S | C₂H₄SCH₃ |
| 161⁴ | H | CH(CH₃)₂ | H | H | F | S | 2-(4-fluorophenoxy)ethyl |
| 162 | H | OCF₃ | H | H | H | S | C(═O)CH₃ |
| 163⁹ | H | SCH₃ | H | H | H | S | C(═O)CH₃ |
| 164 | H | OCF₃ | H | H | H | S | CO₂CH₃ |
| 165 | H | OCF₃ | H | H | H | S | CH₂CO₂C₂H₅ |
| 166 | H | OCF₃ | H | H | H | S | C₃H₆CO₂C₂H₅ |
| 167⁴ | H | OCH₃ | H | H | H | S | C₃H₆CO₂C₄H₉ |
| 168 | H | CH(CH₃)₂ | H | H | F | S | 3-(4-fluorophenylcarbonyl)propyl |
| 169⁴ | H | CH(CH₃)₂ | H | H | F | S | 3-(4-fluorophenylcarbonyl)propyl |
| 170 | H | SCH₃ | H | H | H | S | phenylmethyl |
| 171² | H | Cl | H | H | F | S | 4-fluorophenylmethyl |
| 172 | H | SCH₃ | H | H | H | S | pyrid-4-yl |
| 173 | H | SCH₃ | H | H | H | S | pyrid-4-ylmethyl |

where X is —CR¹¹R¹²CR¹³R¹⁴—; Y is —S—, where R¹, R³ through R⁸,
inclusively, and R¹² through R¹⁴, inclusively, are hydrogen; and

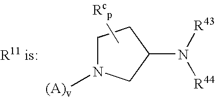

where v is 0; p is 0 and R^{c} is hydrogen:

| Cmpd. | | | | |
|---|---|---|---|---|
| No | R² | R⁴³ | | R⁴⁴ |
| 174 | H | H | | CH₃ |
| 175 | H | CH₃ | | CH₃ |
| 176 | SCH₃ | CH₃ | | CH₃ |
| 177 | CF₃ | CH₃ | | CH₃ |
| 178 | OCF₃ | CH₃ | | CH₃ |
| 179 | | | —C₅H₁₀— | |

where X is —CR¹¹R¹²CR¹³R¹⁴—; where R¹, R³ through R⁸, inclusively,
and R¹² through R¹⁴, inclusively, are hydrogen; and

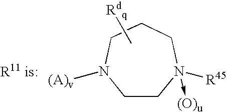

where v is 0; q is 0 and R^{d} is hydrogen; and u is 0:

| Cmpd. | | | |
|---|---|---|---|
| No | Y | R² | R⁴⁵ |
| 180 | S | H | H |
| 181 | S | H | CH₃ |
| 182 | S | H | C₂H₅ |
| 183 | S | SCH₃ | CH₃ |
| 184 | S | CF₃ | CH₃ |
| 185 | S | OCF₃ | CH₃ |
| 186 | O | OCF₃ | CH₃ |

where X is —CR¹⁸R¹⁹NR²⁰—, where R¹⁹ and R²⁰ are hydrogen;

| Cmpd. | | | |
|---|---|---|---|
| No. | R¹ Through R⁸, Inclusively | Y | R¹⁸ |
| 187 | H | S | CH₂NHCH₃ |

where X is —CR²¹═N—;

| Cmpd. | | | R³ Through R⁸, | | |
|---|---|---|---|---|---|
| No. | R¹ | R² | Inclusively | Y | R²¹ |
| 188 | H | Cl | H | S | 1-methylpyrrolidin-3-yloxy |

where X is —CR²¹═N—; where R⁴ through R⁸, inclusively,
R¹², R¹³, and R¹⁴ are hydrogen; and

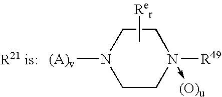

where v is 0; r is 0 and R^{e} is hydrogen; and u is 0:

| Cmpd. | | | | |
|---|---|---|---|---|
| No. | R² | R³ | Y | R⁴⁹ |
| 189 | Cl | H | S | CH₃ |
| 190 | Cl | H | S(O) | CH₃ |
| 191 | Cl | H | S | CH₂CH═CH₂ |
| 192 | H | Cl | S | CH₃ |
| 193 | CH(CH₃)₂ | H | S | CH₃ |
| 194 | OCF₃ | H | S | CH₃ |

where X is —NR¹⁷— and Y is —CR²⁴R²⁵CR²⁶R²⁷—;
where R¹, R³ through R⁷, inclusively, and R²⁴ through R²⁵,
inclusively, are hydrogen; v is 0; and u is 0:

| Cmpd. | | | | |
|---|---|---|---|---|
| No. | R² | R⁸ | R¹⁷ | R⁴⁶ |
| 195 | H | Cl | C₃H₆N(CH₃)₂ | — |
| 196 | H | H | 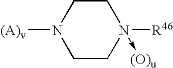 | CH₃ |
| 197 | F | H | 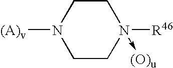 | CH₃ |
| 198 | OCH₃ | H | 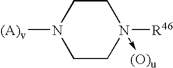 | CH₃ |
| 199 | SCH₃ | H | 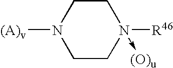 | CH₃ |
| 200 | CF₃ | H | 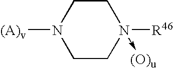 | CH₃ |
| 201 | OCF₃ | H | 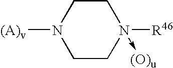 | CH₃ |

where X is —NR¹⁷; and R¹, and R³ through R⁸, inclusively, are hydrogen:

| Cmpd. | | | | | | |
|---|---|---|---|---|---|---|
| No. | Y | R³⁰ | R² | R¹⁷ | R⁴⁷ | R⁴⁸ |
| 202 | S | — | H | C₃H₆NR⁴⁷R⁴⁸ | H | CH₃ |
| 203² | S | — | Cl | C₃H₆NR⁴⁷R⁴⁸ | H | CH(CH₃)CH₂Ph |
| 204⁶ | S | — | Cl | C₃H₆NR⁴⁷R⁴⁸ | CH₃ | CH₃ |
| 205 | S | — | OCH3 | C₃H₆NR⁴⁷R⁴⁸ | CH₃ | CH₃ |
| 206² | S | — | C(O)CH₃ | C₃H₆NR⁴⁷R⁴⁸ | CH₃ | CH₃ |
| 207⁷ | S | — | CF₃ | C₃H₆NR⁴⁷R⁴⁸ | —C₂H₄N(CH₃)C₂H₄— | |
| 208⁷ | S | — | CF₃ | C₃H₆NR⁴⁷R⁴⁸ | —C₂H₄N(C₂H₄OH)C₂H₄— | |
| 209 | O | — | H | C₃H₆NR⁴⁷R⁴⁸ | H | CH₃ |
| 210 | O | — | H | C₃H₆NR⁴⁷R⁴⁸ | H | C₃H₇ |
| 211 | O | — | Cl | C₃H₆NR⁴⁷R⁴⁸ | H | CH₃ |
| 212 | O | — | H | C₃H₆NR⁴⁷R⁴⁸ | CH₃ | CH₃ |
| 213 | NR³⁰ | CH₃ | H | C₃H₆NR⁴⁷R⁴⁸ | CH₃ | CH₃ |

| | | | | | |
|---|---|---|---|---|---|
| 214 | NR³⁰ | C₂H₅ | H | C₃H₆NR⁴⁷R⁴⁸ | —C₅H₁₀— |

where X is —CR¹¹R¹²CR¹³R¹⁴—; where R¹, R³ through R⁸, inclusively, R¹³,
and R¹⁴ are hydrogen, v is 0; m is 0 and R^{b} is hydrogen; and u is 0:

| Cmpd. | | | | | |
|---|---|---|---|---|---|
| No. | R² | R¹¹ | R¹² | Y | R⁴² |
| 215 | | 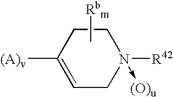 | OH | S | — |
| 216 | OCF₃ | 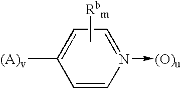 | F | S | CH₃ |

¹methanesulfonate salt;
²maleate salt;
³dimethanesulfonate salt;
⁴dimaleate salt;
⁵oxalate salt;
⁶hydrochloride salt;
⁷dihydrochloride salt;
⁸disulfite salt;
⁹sulfate salt;
¹⁰oxalate salt-bis complex

The compounds of formula I useful in the present invention were tested for insecticidal activity by observing mortality in a population of cotton aphid (Aphis gossypii) on treated cotton plants caused by a test compound, when compared to like populations of cotton aphid on untreated plants. These tests were conducted in the following manner:

For each rate of application of test compound, two seven-to-ten days old cotton seedlings (Gossypium hirsutium) grown in 7.6 cm diameter pots were selected for the test. Each test plant was infested with about 120 adult cotton aphids by placing onto each test plant cuttings of leaves from cotton plants grown in a cotton aphid colony. Once infested, the test plants were maintained for up to about 12 hours to allow complete translocation of the aphids onto the test plant. A solution comprising 1000 part per million (ppm) of each test compound was prepared by dissolving 10 milligrams of the test compound in 1 mL of acetone. Each solution was then diluted with 9 mL of a solution of 0.03 mL of polyoxyethylene(10) isooctylphenyl ether in 100 mL of water. About 2.5 mL of solution of each test compound was needed to spray each replicate of test plant (5 mL total for each test compound). If needed, the solution of 1000 ppm of test compound was serially diluted with a solution of 10% acetone and 300 ppm of polyoxyethylene(10) isooctylphenyl ether in water to provide solutions of each test compound for lower rates of application, for example, 300 ppm, 100 ppm, 30 ppm, or 10 ppm. Each replicate of test plant was sprayed with the solutions of test compound until run-off on both the upper and lower surfaces of the leaves. All the test plants were sprayed using a DeVilbus Atomizer Model 152 (Sunrise Medical, Carlsbad, Calif.) at a pressure of about 0.63-0.74 kilogram per square centimeter from a distance of about 30.5 centimeters from the test plants. For comparison purposes, a solution of a standard, such as amitraz or demethylchlordimeform (DCDM), prepared in a manner analogous to that set forth above, as well as a solution of 10% acetone and 300 ppm of polyoxyethylene(10) isooctylphenyl ether in water containing no test compound were also sprayed onto test plants. Upon completion of spraying the solutions of test compound, the solution of standard, and the solution containing no test compound, the plants were allowed to dry. Upon completion of drying, the test plants were placed in a tray containing about 2.5 centimeters of water, where they were maintained in a growth chamber for 24 hours. After this time, each plant was assessed for percent mortality caused by the test compound when compared to the population of aphids that was infested onto the test plants prior to treatment with test compound. A test compound was designated as possessing insecticidal activity (SA) if there was 20% to 75% mortality of cotton aphid on plants sprayed with that compound. If there was 75% mortality or greater of the cotton aphid, a test compound was designated as being more insecticidally active (A). If there was 20% mortality or less of the cotton aphid, the test compound was termed as inactive (I).

Insecticidal activity data at selected rates of application from this test are provided in Table 2. The test compounds of formula I are identified by numbers that correspond to those in Table 1.

TABLE 2
Insecticidal Activity of Certain Tricyclic Derivatives

Mortality of Cotton
Aphid On Cotton Plants

| Compound | 20% to 75% | More Than 75% |
|---|---|---|
| No. | Mortality (SA) | Mortality (A) |
| 1 | | X |
| 2 | | X |
| 3 | | X |
| 7 | X | |
| 8** | | X |
| 9 | | X |
| 11 | | X |
| 12 | | X |
| 13 | X | |
| 14 | X | |
| 15 | | X |
| 16 | | X |
| 20 | | X |
| 24 | | X |
| 26 | | X |
| 36 | X | |
| 52 | | X |
| 53 | X | |
| 54 | | X |
| 55 | | X |
| 56 | X | |
| 57 | | X |
| 59 | | X |
| 60 | | X |
| 61 | | X |
| 62 | | X |
| 63 | X | |
| 64** | | X |
| 65** | | X |
| 66* | | X |
| 67** | | X |
| 68 | | X |
| 69* | X | |
| 70* | | X |
| 71 | | X |
| 72** | | X |
| 73** | | X |
| 74** | | X |
| 75** | | X |
| 76 | | X |
| 77** | | X |
| 78** | | X |
| 79** | | X |
| 80** | | X |
| 81** | | X |
| 82** | | X |
| 83** | | X |
| 84** | | X |
| 85** | | X |
| 86 | X | |
| 87 | | X |
| 88** | | X |
| 89** | | X |
| 90 | | X |
| 91 | | X |
| 92 | X | |
| 94** | | X |
| 95 | | X |
| 96** | | X |
| 97** | | X |
| 98** | | X |
| 99** | | X |
| 100** | | X |
| 101** | X | |
| 102** | X | |
| 103** | | X |
| 104** | | X |
| 105** | | X |
| 106** | | X |
| 107** | | X |
| 108** | | X |
| 109** | | X |
| 110** | | X |
| 111** | | X |
| 112** | | X |
| 113** | | X |
| 114 | | X |
| 115** | | X |
| 116 | | X |
| 117 | | X |
| 118** | | X |
| 119** | | X |
| 120 | | X |
| 121 | X | |
| 122** | | X |
| 123** | | X |
| 124** | | X |
| 125** | | X |
| 126** | | X |
| 127** | | X |
| 128** | | X |
| 129 | | X |
| 131 | | |
| 138** | | X |
| 139** | | X |
| 140** | | X |
| 141 | X | |
| 142 | | X |
| 143 | | X |
| 144** | | X |
| 145** | | X |
| 146** | | X |
| 147 | X | |
| 148 | | X |
| 149** | X | |
| 150** | | X |
| 151 | | X |
| 152** | X | |
| 153** | X | |
| 154** | | X |
| 155** | | X |
| 156 | | X |
| 157** | | X |
| 158** | | X |
| 159 | | X |
| 160** | | X |
| 161** | | X |
| 162 | | X |
| 163** | | X |
| 164 | | X |
| 165 | | X |
| 166** | | X |
| 167** | X | |
| 168** | | X |
| 169** | | X |
| 170 | | X |
| 171** | X | |
| 172 | X | |
| 173** | | X |
| 178 | | X |
| 183** | | X |
| 185** | | X |
| 186** | | X |
| 187** | | X |
| 188 | | X |
| 189 | | X |
| 190 | | X |
| 191 | | X |
| 192 | | X |
| 193 | | X |
| 194 | | X |
| 203** | | X |
| 204** | X | |
| 205** | | X |
| 206**² | | X |
| 207** | | X |
| 208** | | X |
| 217 | | X |

Rate of application 1000 ppm
*Rate of application 300 ppm
**Rate of application 100 ppm

As set forth in Table 2, most all the compounds of formula I tested provided 75% mortality or more of cotton aphid.

In a test conducted in the same manner as set forth above, certain compounds of formula I were tested to determine a more definitive percent mortality of cotton aphid. Insecticidal activity data at selected rates of application and insect exposure times from this test are provided in Table 3.

TABLE 3
Insecticidal Activity of Certain Tricyclic Derivatives

| | Rate of | | Percent Mortality of | Aphid | |
|---|---|---|---|---|---|
| Compound | Application | | Cotton Aphid on | Exposure to Test | |
| No. | (ppm) | | Cotton Plants | Compound (Hours) | |
| 2 | 100 | ppm | 80% | 96 | hours |
| 3 | 100 | | 80 | 96 | |
| 8 | 100 | | 88 | 96 | |
| 9 | 100 | | 26 | 72 | |
| 11 | 100 | | 42 | 96 | |
| 12 | 100 | | 26 | 72 | |
| 15 | 100 | | 28 | 96 | |
| 20 | 100 | | 37 | 72 | |
| 26 | 100 | | 84 | 72 | |
| 52 | 300 | | 100 | 72 | |
| 64 | 100 | | 74 | 168 | |
| 65 | 100 | | 100 | 168 | |
| 66 | 100 | | 61 | 168 | |
| 67 | 100 | | 75 | 168 | |
| 69 | 100 | | 69 | 168 | |
| 70 | 100 | | 57 | 168 | |
| 71 | 100 | | 100 | 168 | |
| 72 | 100 | | 100 | 168 | |
| 73 | 100 | | 35 | 168 | |
| 75 | 100 | | 86 | 168 | |
| 76 | 100 | | 32 | 168 | |
| 77 | 100 | | 37 | 168 | |
| 78 | 100 | | 53 | 168 | |
| 79 | 100 | | 35 | 168 | |
| 80 | 1000 | | 83 | 168 | |
| 82 | 100 | | 98 | 168 | |
| 83 | 100 | | 41 | 168 | |
| 85 | 1000 | | 92 | 168 | |
| 87 | 1000 | | 97 | 168 | |
| 88 | 100 | | 35 | 168 | |
| 89 | 100 | | 55 | 168 | |
| 90 | 1000 | | 74 | 168 | |
| 92 | 100 | | 48 | 72 | |
| 94 | 1000 | | 100 | 72 | |
| 95 | 1000 | | 82 | 72 | |
| 96 | 300 | | 100 | 168 | |
| 97 | 100 | | 65 | 72 | |
| 98 | 100 | | 90 | 168 | |
| 99 | 1000 | | 100 | 168 | |
| 100 | 1000 | | 82 | 96 | |
| 101 | 100 | | 60 | 72 | |
| 102 | 100 | | 33 | 72 | |
| 103 | 1000 | | 90 | 72 | |
| 104 | 100 | | 75 | 168 | |
| 105 | 1000 | | 85 | 96 | |
| 106 | 1000 | | 100 | 96 | |
| 107 | 100 | | 82 | 168 | |
| 108 | 1000 | | 100 | 168 | |
| 109 | 1000 | | 100 | 168 | |
| 110 | 300 | | 65 | 168 | |
| 111 | 100 | | 94 | 72 | |
| 112 | 100 | | 92 | 72 | |
| 113 | 100 | | 78 | 72 | |
| 115 | 100 | | 93 | 72 | |
| 118 | 100 | | 85 | 72 | |
| 119 | 100 | | 85 | 72 | |
| 121 | 1000 | | 65 | 72 | |
| 122 | 100 | | 88 | 72 | |
| 123 | 100 | | 96 | 72 | |
| 124 | 100 | | 95 | 72 | |
| 125 | 100 | | 90 | 72 | |
| 126 | 100 | | 100 | 168 | |
| 127 | 1000 | | 100 | 168 | |
| 128 | 100 | | 95 | 72 | |
| 131 | 100 | | 90 | 168 | |
| 138 | 1000 | | 100 | 168 | |
| 139 | 100 | | 96 | 168 | |
| 140 | 1000 | | 73 | 168 | |
| 144 | 100 | | 100 | 168 | |
| 145 | 100 | | 98 | 144 | |
| 146 | 300 | | 88 | 72 | |
| 149 | 100 | | 68 | 168 | |
| 150 | 100 | | 93 | 72 | |
| 151 | 300 | | 72 | 72 | |
| 152 | 300 | | 74 | 168 | |
| 153 | 300 | | 93 | 168 | |
| 154 | 100 | | 83 | 72 | |
| 155 | 100 | | 73 | 72 | |
| 156 | 100 | | 55 | 168 | |
| 157 | 100 | | 64 | 144 | |
| 158 | 300 | | 82 | 72 | |
| 159 | 100 | | 28 | 72 | |
| 160 | 100 | | 71 | 72 | |
| 161 | 100 | | 73 | 72 | |
| 162 | 300 | | 31 | 168 | |
| 163 | 1000 | | 96 | 168 | |
| 166 | 100 | | 78 | 144 | |
| 167 | 300 | | 66 | 168 | |
| 168 | 100 | | 77 | 72 | |
| 169 | 100 | | 71 | 72 | |
| 171 | 100 | | 85 | 72 | |
| 173 | 1000 | | 82 | 96 | |
| 183 | 1000 | | 100 | 168 | |
| 185 | 1000 | | 100 | 168 | |
| 186 | 100 | | 100 | 168 | |
| 187 | 100 | | 94 | 168 | |
| 189 | 1000 | | 55 | 168 | |
| 194 | 100 | | 51 | 168 | |
| 205 | 500 | | 40 | 72 | |
| 207 | 1000 | | 25 | 72 | |
| 208 | 500 | | 43 | 72 | |

As set forth in Table 3, compounds of formula I tested in this test, 60% of the compounds provided 75% or greater mortality of cotton aphid, while the remaining compounds of formula I, provided 26% to 74% control of cotton aphid.

While this invention has been described with an emphasis upon preferred embodiments, it will be understood by those of ordinary skill in the art that variations of the preferred embodiments may be used and that it is intended that the invention may be practiced otherwise than as specifically described herein. Accordingly, this invention includes all modifications encompassed within the spirit and scope of the invention as defined by the following claims.

What is claimed is:

1. An insecticidal composition comprising at least one of an insecticidally effective amount of a compound of formula I and at least one insecticidally compatible carrier therefor, wherein the compound of formula I is: 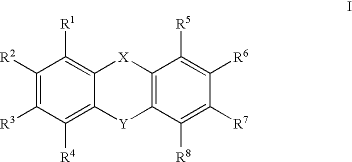
wherein
R¹ through R⁸, inclusively, are independently selected from hydrogen, halogen, alkyl, cycloalkyl, alkenyl, alkynyl, trialkylsilylalkynyl, alkoxy, haloalkyl, haloalkoxy, alkylthio, alkylsulfinyl, alkylsulfonyl, haloalkylthio, haloalkylsulfinyl, haloalkylsulfonyl, dialkylaminosulfonyl, nitro, cyano, amino, formyl, or alkylcarbonyl;
X is selected from —CR⁹R¹⁰—, —CR¹¹R¹²CR¹³R¹⁴—, —CR¹⁵═CR¹⁶—, NR¹⁷—, —CR¹⁸R¹⁹NR²⁰—, or C²¹═N—;
and
Y is selected from —CR²²R²³—, —CR²⁴R²⁵CR²⁶R²⁷, CR²⁸CR²⁹—, N³⁰—, —CR³¹R³²NR³³—, —O—, —S—, —S(O)—, —S(O)₂—, —CR³⁴R³⁵O—, —CR³⁶R³⁷S—, or —CR³⁸═N—;
where
R⁹ and R¹⁰ are independently selected from hydrogen, alkyl, or (piperidin-4-yl)alkyl;
or
R⁹ and R¹⁰ may be taken together with 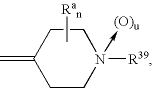
or with ═CHC₂H₄NR⁴⁰R⁴¹,
where
R³⁹, R⁴⁰ and R⁴¹ are independently selected from hydrogen; alkyl; hydroxylalkyl; alkoxyalkyl; alkylthioalkyl; alkoxycarbonylalkyl; haloalkoxycarbonyl; arylalkyl; aryloxyalkyl; arylcarbonylalkyl; arylcarbonyloxyalkyl, wherein aryl is optionally substituted with one or more halogen, alkoxy, haloalkyl, or aryl;
or
R⁴⁰ and R⁴¹ may be taken together with —C₂H₄N(CH₃)C₂H₄— to form a piperazine ring;
u is 0 or 1,
and when u is 1, an N-oxide is formed;
n is 0, and R^{a} is hydrogen;
or
n is 1 to 8, and R^{a} is selected from one or more of alkyl, alkoxyalkyl, alkoxycarbonyl, and aryl, wherein aryl is optionally substituted with one or more halogen, alkoxy, haloalkyl, or aryl;
R¹¹ is selected from hydrogen, alkyl, alkylaminoalkoxy, dialkylaminoalkoxy, N(alkyl)(alkylaminoalkyl), N(alkyl)(dialkylaminoalkyl), alkylaminoalkylalkynyl, dialkylaminoalkylalkynyl, morpholinyl, imidazolinyl, alkylpyrrolidinyloxy, 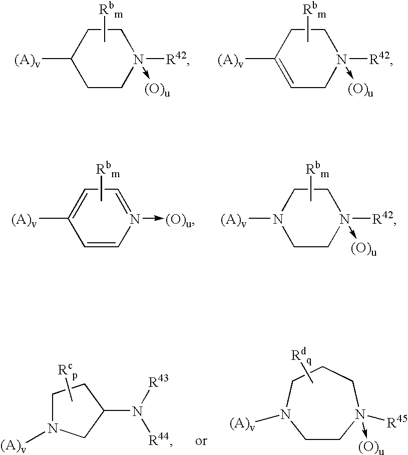
where
v is 0 or 1,
and when v is 1, A is a bridging group selected from —O—, —S—, —NH—, and —CH₂—;
u is as described above;
R⁴² through R⁴⁵, inclusively, are independently selected from hydrogen; alkyl; alkenyl; alkynyl; hydroxylalkyl; alkoxyalkyl; alkylthioalkyl; alkylcarbonyl; alkoxycarbonylalkyl; haloalkoxycarbonyl; arylalkyl; aryloxyalkyl; arylcarbonylalkyl; arylcarbonyloxyalkyl; heteroaryl; heteroarylalkyl; heteroarylalkylamino; wherein aryl and heteroaryl are optionally substituted with one or more halogen, alkoxy, haloalkyl, or aryl;
or
R⁴³ and R⁴⁴ may be taken together with —C₅H₁₀— to form a piperidine ring;
m, p, and q are 0, and R^{b}, R^{c} and R^{d} are hydrogen;
or
m is 1 to 8, p is 1 to 7, and q is 1 to 10, and R^{b}, R^{c}, and R^{d}, respectively, are independently selected from one or more of alkyl, alkoxyalkyl, alkylamino, dialkylamino, alkoxycarbonyl, or aryl, wherein aryl is optionally substituted with one or more halogen, alkoxy, haloalkyl, or aryl;
or
R¹¹ and R¹² may be taken together with 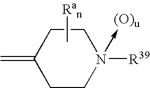
where R^{a}, n, u, and R³⁹ are as described above;
R², when not taken together with R¹¹, and R¹³, R¹⁴, and R¹⁶, are independently selected from hydrogen, hydroxy, halogen, alkyl, alkoxy, alkylcarbonyl, alkylcarbonyloxy, alkoxycarbonyl, alkoxycarbonyloxy, alkylaminocarbonyl, dialkylaminocarbonyl, alkylaminocarbonyloxy, dialkylaminocarbonyloxy, alkylaminosulfonyl, or dialkylaminosulfonyl;
R¹⁵ is selected from 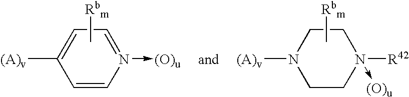
where m, u, v, A, R^{b} and R⁴² are as described above;
R¹⁷ is hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl; 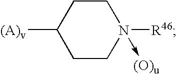
or —C₃H₆NR⁴⁷R⁴⁸
where
A, v, and u are as described above;
R⁴⁶ is selected from selected from hydrogen; alkyl; alkenyl; alkynyl; hydroxylalkyl; alkoxyalkyl; alkylthioalkyl; alkylcarbonyl; alkoxycarbonylalkyl; haloalkoxycarbonyl; arylalkyl; aryloxyalkyl; arylcarbonylalkyl; arylcarbonyloxyalkyl; heteroaryl; heteroarylalkyl; heteroarylalkylamino; wherein aryl and heteroaryl are optionally substituted with one or more halogen, alkoxy, haloalkyl, or aryl;
R⁴⁷ and R⁴⁸ are independently selected from hydrogen and alkyl;
or
R⁴⁷ and R⁴⁸ may be taken together with —C₅H₁₀— to form a piperidine ring, or with —C₂H₄N(CH₃)C₂H₁—, or —C₂H(C₂H₄OH)C₂H₄— to form a piperazine ring;
R¹⁸ and R¹⁹ are independently selected from hydrogen, alkyl, amino, alkylaminoalkyl, and dialkylaminoalkyl;
R²⁰ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R²¹ is selected from hydrogen, alkyl, 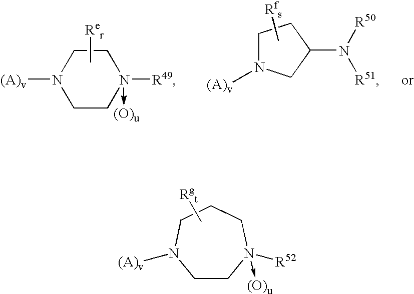
where
A, v, and u are as described above;
R⁴⁹ through R⁵², inclusively, are independently selected from hydrogen; alkyl; alkenyl, alkynyl, hydroxylalkyl; alkoxyalkyl; alkylthioalkyl; alkylcarbonyl, alkoxycarbonylalkyl; haloalkoxycarbonyl; arylalkyl; aryloxyalkyl; arylcarbonylalkyl; arylcarbonyloxyalkyl, heteroaryl, heteroarylalkyl, heteroarylalkylamino, wherein aryl and heteroaryl are optionally substituted with one or more halogen, alkoxy, haloalkyl, or aryl;
or
R⁵⁰ and R⁵¹ may be taken together with —C₅H₁₀— to form a piperidine ring;
r, s, and t are 0, and R^{e}, R^{f}, and R^{g} are hydrogen,
or
r is 1 to 8, s is 1 to 7, t is 1 to 10, and R^{e}, R^{f}, and R^{g}, respectively, are independently selected from one or more of alkyl, alkoxyalkyl, alkylamino, dialkylamino, alkoxycarbonyl, or aryl, wherein aryl is optionally substituted with one or more halogen, alkoxy, haloalkyl, or aryl;
R²² through R²⁹, inclusively, are independently selected from hydrogen, and alkyl;
R³⁰ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R³¹ and R³² are independently selected from hydrogen, and alkyl,
R³³ is selected from hydrogen; alkyl; alkoxyalkyl; alkoxycarbonyl; dialkylaminoalkyl; alkylaminocarbonyl; dialkylaminocarbonyl; alkylsulfonyl; aryl, and arylalkyl wherein aryl is optionally substituted with one or more halogen, alkoxy, haloalkyl, or aryl;
R³⁴ through R³⁸, inclusively, are independently selected from hydrogen, and alkyl;
and,
agriculturally acceptable salts thereof.

2. An insecticidal composition of claim 1, wherein X is —CR⁹R¹⁰— and Y is selected from —O—, —S—, —CR²²R²³—, and —CR³⁴R³⁵O—;
where
R⁹ and R¹⁰ are taken together with 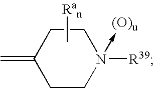
where
R³⁹ is selected from hydrogen; alkyl; hydroxylalkyl; alkoxyalkyl; alkylthioalkyl; alkoxycarbonylalkyl; haloalkoxycarbonyl; arylalkyl; aryloxyalkyl; arylcarbonylalkyl; arylcarbonyloxyalkyl, wherein aryl is optionally substituted with one or more halogen, alkoxy, haloalkyl, or aryl;
and,
R²², R¹, R³⁴ and R³⁵ are independently selected from hydrogen and alkyl.

3. An insecticidal composition of claim 1, wherein X is —CR¹¹R¹²CR¹³R¹⁴— and Y is selected from —O—, —S— and —CR²²R²³—;
where
R¹¹ is selected from 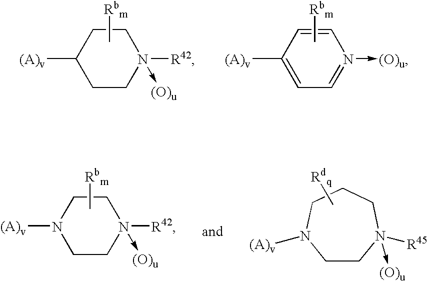
where
R⁴² and R⁴⁵ are independently selected from hydrogen; alkyl; alkenyl; alkynyl; hydroxylalkyl; alkoxyalkyl; alkylthioalkyl; alkylcarbonyl; alkoxycarbonylalkyl; haloalkoxycarbonyl; arylalkyl; aryloxyalkyl; arylcarbonylalkyl; arylcarbonyloxyalkyl; heteroaryl; heteroarylalkyl; heteroarylalkylamino; wherein aryl and heteroaryl are optionally substituted with one or more halogen, alkoxy, haloalkyl, or aryl;
R¹² is selected from selected from hydrogen, hydroxy, halogen, alkyl, alkoxy, alkylcarbonyl, alkylcarbonyloxy, alkoxycarbonyl, alkoxycarbonyloxy, alkylaminocarbonyl, dialkylaminocarbonyl, alkylaminocarbonyloxy, dialkylaminocarbonyloxy, alkylaminosulfonyl, and dialkylaminosulfonyl;
R¹³ and R¹⁴ are hydrogen;
and,
R²² and R²³ are independently selected from hydrogen and alkyl.

4. An insecticidal composition of claim 1, wherein X is —CR¹⁸R¹⁹NR²⁰— and Y is selected from —O—, —S— and —CR²²R²³—;
where
R²⁰ is selected from hydrogen, alkyl, alkoxyalkyl, alkoxycarbonyl, dialkylaminoalkyl, alkylaminocarbonyl, and dialkylaminocarbonyl; and,
R²² and R²³ are independently selected from hydrogen and alkyl.

5. An insecticidal composition of claim 1, wherein X is —CR²¹═N— and Y is selected from —S— and —CR²²R²³—;
where R²¹ is 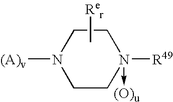
where
R⁴⁹ is selected from hydrogen; alkyl; alkenyl, alkynyl, hydroxylalkyl; alkoxyalkyl; alkylthioalkyl; alkylcarbonyl, alkoxycarbonylalkyl; haloalkoxycarbonyl; arylalkyl; aryloxyalkyl; arylcarbonylalkyl; arylcarbonyloxyalkyl, heteroaryl, heteroarylalkyl, heteroarylalkylamino, wherein aryl and heteroaryl are optionally substituted with one or more halogen, alkoxy, haloalkyl, or aryl;
and,
R²² and R²³ are independently selected from hydrogen and alkyl.

6. The insecticidal composition of claim 1, further comprising one or more second compounds.

7. The insecticidal composition of claim 2, further comprising one or more second compounds.

8. The insecticidal composition of claim 3, further comprising one or more second compounds.

9. The insecticidal composition of claim 4, further comprising one or more second compounds.

10. The insecticidal composition of claim 5, further comprising one or more second compounds.

11. A method of controlling insects, comprising applying an insecticidally effective amount of a composition of claim 1 to a locus where insects are present or are expected to be present.

12. A method of controlling insects, comprising applying an insecticidally effective amount of a composition of claim 2 to a locus where insects are present or are expected to be present.

13. A method of controlling insects, comprising applying an insecticidally effective amount of a composition of claim 3 to a locus where insects are present or are expected to be present.

14. A method of controlling insects, comprising applying an insecticidally effective amount of a composition of claim 4 to a locus where insects are present or are expected to be present.

15. A method of controlling insects, comprising applying an insecticidally effective amount of a composition of claim 5 to a locus where insects are present or are expected to be present.

16. A method of controlling insects, comprising applying an insecticidally effective amount of a composition of claim 6 to a locus where insects are present or are expected to be present.

17. A method of controlling insects, comprising applying an insecticidally effective amount of a composition of claim 7 to a locus where insects are present or are expected to be present.

18. A method of controlling insects, comprising applying an insecticidally effective amount of a composition of claim 8 to a locus where insects are present or are expected to be present.

19. A method of controlling insects, comprising applying all insecticidally effective amount of a composition of claim 9 to a locus where insects are present or are expected to be present.

20. A method of controlling insects, comprising applying an insecticidally effective amount of a composition of claim 10 to a locus where insects are present or are expected to be present.
